(19) United States
(12) Patent Application Publication
(10) Pub. No.: US 2026/0238815 A1
(43) Pub. Date: Aug. 13, 2026

(54) A METHOD, AN APPARATUS AND A COMPUTER PROGRAM PRODUCT FOR VIDEO ENCODING AND VIDEO DECODING

(71) Applicant: Nokia Technologies Oy, Espoo (FI)

(72) Inventors: Patrice RONDAO ALFACE, Antwerp (BE); Aleksei MARTEMIANOV, Tampere (FI); Lukasz KONDRAD, Munich (DE); Sebastian SCHWARZ, Munich (DE)

(21) Appl. No.: 19/153,849

(22) PCT Filed: Jan. 22, 2024
(86) PCT No.: PCT/FI2024/050022

§ 371 Date: Aug. 5, 2025

(30) Foreign Application Priority Data
Feb. 17, 2023 (FI) 20235206

(51) Int. Cl. H04N 19/597; G06T 9/00; G06T 17/20; H04N 19/31; H04N 19/33; H04N 19/63

(52) U.S. Cl. CPC H04N 19/597; G06T 9/001; G06T 17/20; H04N 19/31; H04N 19/33; H04N 19/63

(57) ABSTRACT

The embodiments relate to a method for encoding, wherein a base mesh is generated (2810), and the base mesh iteratively subdivided (2815), which results in a hierarchy of levels of detail and a subdivided mesh. The method comprises applying (2820) temporal and spatial lifting schemes to generate first and second type of low and high frequency wavelet coefficients, respectively, wherein the first type of low and high frequency wavelet coefficients are used as samples when generating the second type of low and high frequency wavelet coefficients for each level of detail; compressing (2825) data streams corresponding to each combination of spatial and temporal levels of details into one or more bitstreams; and transmitting (2830) the one or more bitstreams to a decoder. The embodiments also relate to a method for decoding, and technical equipment for implementing the methods.

### TECHNICAL FIELD

The present solution generally relates to encoding and decoding of volumetric video.

### BACKGROUND

Volumetric video data represents a three-dimensional (3D) scene or object and can be used as input for AR (Augmented Reality), VR (Virtual Reality), and MR (Mixed Reality) applications. Such data describes geometry (Shape, size, position in 3D space) and respective attributes (e.g., color, opacity, reflectance, . . . ), and any possible temporal transformations of the geometry and attributes at given time instances (like frames in two-dimensional (2D) video). Volumetric video can be generated from 3D models, also referred to as volumetric visual objects, i.e., CGI (Computer Generated Imagery), or captured from real-world scenes using a variety of capture solutions, e.g., multi-camera, laser scan, combination of video and dedicated depth sensors, and more. Also, a combination of CGI and real-world data is possible. Examples of representation formats for volumetric data comprise triangle meshes, point clouds, or voxels. Temporal information about the scene can be included in the form of individual capture instances, i.e., “frames” in 2D video, or other means, e.g., position of an object as a function of time.

Because volumetric video describes a 3D scene (or object), such data can be viewed from any viewpoint. Therefore, volumetric video is an important format for any AR, VR or MR applications, especially for providing 6DOF (6 Degrees Of Freedom) viewing capabilities.

Increasing computational resources and advances in 3D data acquisition devices have enabled reconstruction of highly detailed volumetric video representations of natural scenes. Infrared, lasers, time-of-flight, and structured light are examples of devices that can be used to construct 3D video data. Representation of the 3D data depends on how the 3D data is used.

Dense Voxel arrays have been used to represent volumetric medical data. In 3D graphics, polygonal meshes are extensively used. Point clouds on the other hand are well suited for applications such as capturing real world 3D scenes where the topology is not necessarily a 2D manifold. Another way to represent 3D data is coding, this 3D data as set of texture and depth map as is the case in the multi-view plus depth. Closely related to the techniques used in multi-view plus depth is the use of elevation maps, and multi-level surface maps.

### SUMMARY

The scope of protection sought for various embodiments of the invention is set out by the independent claims. The embodiments and features, if any, described in this specification that do not fall under the scope of the independent claims are to be interpreted as examples useful for understanding various embodiments of the invention.

Various aspects include a method, an apparatus and a computer readable medium comprising a computer program stored therein, which are characterized by what is stated in the independent claims. Various embodiments are disclosed in the dependent claims.

According to a first aspect, there is provided an apparatus for encoding comprising means for receiving a textured mesh sequence comprising mesh frames, wherein the mesh represents a three-dimensional object; means for generating a base mesh for a mesh frame; means for iteratively subdividing the base mesh, which results in a hierarchy of levels of detail and a subdivided mesh; based on the mesh frames, means for applying a first type of lifting scheme to generate first type of low and high frequency wavelet coefficients and means for applying a second type of lifting scheme to generate a second type of low and high frequency wavelet coefficients, wherein the first type of low and high frequency wavelet coefficients are used as samples when generating the second type of low and high frequency wavelet coefficients for each level of detail, wherein the first type of lifting scheme and second type of lifting scheme comprises temporal lifting scheme and spatial lifting scheme with corresponding levels of details; means for compressing data streams corresponding to each combination of spatial and temporal levels of details into one or more bitstreams; and means for transmitting the one or more bitstreams to a decoder.

According to a second aspect, there is provided an apparatus for decoding comprising means for receiving one or more bitstreams; means for decompressing data streams corresponding to combinations of spatial and temporal levels of details from said one or more bitstreams; means for decoding first type of low and high frequency wavelet coefficients and second type of low and high frequency wavelet coefficients; and means for applying an inverse first type of lifting scheme and an inverse second type of lifting scheme according to the first type of low and high frequency wavelet coefficients and the second type of low and high frequency wavelet coefficients to reconstruct mesh frames.

According to a third aspect, there is provided a method for encoding, comprising: receiving a textured mesh sequence comprising mesh frames, wherein the mesh represents a three-dimensional object; generating a base mesh for a mesh frame; iteratively subdividing the base mesh, which results in a hierarchy of levels of detail and a subdivided mesh; based on the mesh frames, applying a first type of lifting scheme to generate first type of low and high frequency wavelet coefficients and applying a second type of lifting scheme to generate a second type of low and high frequency wavelet coefficients, wherein the first type of low and high frequency wavelet coefficients are used as samples when generating the second type of low and high frequency wavelet coefficients for each level of detail, wherein the first type of lifting scheme and second type of lifting scheme comprises temporal lifting scheme and spatial lifting scheme with corresponding levels of details; compressing data streams corresponding to each combination of spatial and temporal levels of details into one or more bitstreams; and transmitting the one or more bitstreams to a decoder.

According to a fourth aspect, there is provided a method for decoding, comprising: receiving one or more bitstreams; decompressing data streams corresponding to combinations of spatial and temporal levels of details from said one or more bitstreams; decoding the first type of low and high frequency wavelet coefficients and the second type of low and high frequency wavelet coefficients; and applying an inverse first type of lifting scheme and an inverse second type of lifting scheme according to first type of low and high frequency wavelet coefficients and second type of low and high frequency wavelet coefficients to reconstruct mesh frames.

According to a fifth aspect, there is provided an apparatus for encoding comprising at least one processor, memory including computer program code, the memory and the computer program code configured to, with the at least one processor, cause the apparatus to perform at least the following: receive a textured mesh sequence comprising mesh frames, wherein the mesh represents a three-dimensional object; generate a base mesh for a mesh frame; iteratively subdivide the base mesh, which results in a hierarchy of levels of detail and a subdivided mesh; based on the mesh frames, apply a first type of lifting scheme to generate first type of low and high frequency wavelet coefficients and apply a second type of lifting scheme to generate a second type of low and high frequency wavelet coefficients, wherein the first type of low and high frequency wavelet coefficients are used as samples when generating the second type of low and high frequency wavelet coefficients for each level of detail, wherein the first type of lifting scheme and the second type of lifting scheme comprises temporal lifting scheme and spatial lifting scheme with corresponding levels of details; compress data streams corresponding to each combination of spatial and temporal levels of details into one or more bitstreams; and transmit the one or more bitstreams to a decoder.

According to a sixth aspect, there is provided an apparatus for decoding comprising at least one processor, memory including computer program code, the memory and the computer program code configured to, with the at least one processor, cause the apparatus to perform at least the following: receive one or more bitstreams; decompress data streams corresponding to combinations of spatial and temporal levels of details from said one or more bitstreams; decode first type of low and high frequency wavelet coefficients and second type of low and high frequency wavelet coefficients; and apply an inverse first type of lifting scheme and an inverse second type of lifting scheme according to the first type of low and high frequency wavelet coefficients and the second type of low and high frequency wavelet coefficients to reconstruct mesh frames.

According to a seventh aspect, there is provided computer program product for encoding comprising computer program code configured to, when executed on at least one processor, cause an apparatus or a system to: receive a textured mesh sequence comprising mesh frames, wherein the mesh represents a three-dimensional object; generate a base mesh for a mesh frame; iteratively subdivide the base mesh, which results in a hierarchy of levels of detail and a subdivided mesh; based on the mesh frames, apply a first type of lifting scheme to generate first type of low and high frequency wavelet coefficients and apply a second type of lifting scheme to generate a second type of low and high frequency wavelet coefficients, wherein the first type of low and high frequency wavelet coefficients are used as samples when generating the second type of low and high frequency wavelet coefficients for each level of detail, wherein the first type of lifting scheme and the second type of lifting scheme comprises temporal lifting scheme and spatial lifting scheme with corresponding levels of details; compress data streams corresponding to each combination of spatial and temporal levels of details into one or more bitstreams; and transmit the one or more bitstreams to a decoder.

According to an eighth aspect, there is provided computer program product for decoding comprising computer program code configured to, when executed on at least one processor, cause an apparatus or a system to: receive one or more bitstreams; decompress data streams corresponding to combinations of spatial and temporal levels of details from said one or more bitstreams; decode first type of low and high frequency wavelet coefficients and second type of low and high frequency wavelet coefficients; and apply an inverse first type of lifting scheme and an inverse second type of lifting scheme according to the first type of low and high frequency wavelet coefficients and the second type of low and high frequency wavelet coefficients to reconstruct mesh frames.

According to an embodiment, wherein the first type of lifting scheme and the second type of lifting scheme is applied on a level following a lowest level of detail based on the base mesh frames and the subdivided mesh frames at said level following the lowest level of detail.

According to an embodiment, wherein the first type of lifting scheme and the second type of lifting scheme is applied on subsequent levels based on mesh frames subdivided at the previous level of details and mesh frames subdivided at the current level of detail.

According to an embodiment, wherein the first type of lifting scheme is temporal lifting scheme, whereupon the mesh frames are separated into two subsequences according to frame indices and the temporal low and high frequency wavelet coefficients are defined according to said subsequences.

According to an embodiment, wherein the first type of lifting scheme is a spatial lifting scheme, whereupon base meshes are used as low frequency spatial wavelet coefficients and filtered displacement vectors are used as high-frequency spatial wavelet coefficients.

According to an embodiment, wherein the second type of low and high frequency wavelet coefficients are predicted based on the first type of low and high frequency wavelet coefficients.

According to an embodiment, wherein information on the used temporal lifting scheme and spatial lifting scheme is encoded into or along a bitstream for a frame or a sequence.

According to an embodiment, wherein information on type and frequency band of the lifting scheme subband or level of detail is encoded into or along a bitstream for a frame or a sequence.

According to an embodiment, the computer program product is embodied on a non-transitory computer readable medium.

### DESCRIPTION OF THE DRAWINGS

In the following, various embodiments will be described in more detail with reference to the appended drawings, in which

FIG. 1a shows an example of a volumetric media conversion;

FIG. 1b shows an example of a volumetric media reconstruction;

FIG. 2 shows an example of block to patch mapping;

FIG. 3a shows an example of an atlas coordinate system;

FIG. 3b shows an example of a local 3D patch coordinate system;

FIG. 3c shows an example of a final target 3D coordinate system;

FIG. 4 shows an example of V-PCC extension for mesh encoding;

FIG. 5 shows an example of V-PCC extension for mesh decoding;

FIG. 6 shows an example of a subdivision step of a triangle into four triangles;

FIG. 7 shows an example of multi-resolution analysis of a mesh;

FIG. 8 shows an example of an encoding process comprising pre-processing;

FIG. 9 shows example of pre-processing steps at an encoder;

FIG. 10 shows an example of intra frame encoder;

FIG. 11 shows an example of inter frame encoder;

FIG. 12 shows an example of a decoding process comprising post-processing;

FIG. 13 shows an example of decoding process in intra mode;

FIG. 14 shows an example of decoding process in inter mode;

FIG. 15 shows an example of a base mesh encoder in a VDMC encoder;

FIG. 16 shows an example of a base mesh encoder;

FIG. 17 shows an example of a base mesh decoder;

FIG. 18 shows an example of segmentation of a mesh into sub-meshes;

FIG. 19 shows an example with two submeshes;

FIG. 20 shows an example of displacement video components for two consecutive frames;

FIG. 21 shows an example of temporal lifting scheme for mesh sequences;

FIG. 22 shows an example of forward lifting scheme;

FIG. 23 shows an example of backwards lifting scheme;

FIG. 24 shows an example of a spatio-temporal wavelet decomposition;

FIG. 25 shows an example of spatio-temporal decomposition;

FIG. 26 shows an example of a modified V-DMC encoder for 3D+T wavelet decomposition;

FIG. 27 shows an example of a modified V-DMC decoder for 3D+T wavelet decomposition;

FIG. 28 is a flowchart illustrating a method for encoding according to an embodiment;

FIG. 29 is a flowchart illustrating a method for decoding according to another embodiment; and

FIG. 30 shown an example of an apparatus.

### DESCRIPTION OF EXAMPLE EMBODIMENTS

The present embodiments relate to encoding, signalling, and rendering a volumetric video based on mesh coding. In particular, the present embodiments provide spatio-temporal lifting scheme, i.e., three-dimensional and time (also referred to as “3D+T”) displacement wavelet transform for coding and decoding of dynamic meshes.

The following description and drawings are illustrative and are not to be construed as unnecessarily limiting. The specific details are provided for a thorough understanding of the disclosure. However, in certain instances, well-known or conventional details are not described in order to avoid obscuring the description. References to one or an embodiment in the present disclosure can be, but not necessarily are, reference to the same embodiment and such references mean at least one of the embodiments.

Reference in this specification to “one embodiment” or “an embodiment” means that a particular feature, structure, or characteristic described in connection with the embodiment in included in at least one embodiment of the disclosure.

Volumetric video data represents a three-dimensional scene or object and can be used as input for AR, VR and MR applications. Such data describes geometry (shape, size, position in 3D space) and respective attributes (e.g., color, opacity, reflectance, . . . ), plus any possible temporal transformations of the geometry and attributes at given time instances (like frames in 2D video). Volumetric video is either generated from 3D models, i.e., CGI, or captured from real-world scenes using a variety of capture solutions, e.g., multi-camera, laser scan, combination of video and dedicated depth sensors, and more. Also, a combination of CGI and real-world data is possible. Representation formats for such volumetric data are triangle meshes, point clouds, or voxels. Temporal information about the scene can be included in the form of individual capture instances, i.e., “frames” in 2D video, or other means, e.g., position of an object as a function of time.

Because volumetric video describes a 3D scene (or object), such data can be viewed from any viewpoint. Therefore, volumetric video is an important format for any AR, VR or MR applications, especially for providing 6DOF viewing capabilities.

Increasing computational resources and advances in 3D data acquisition devices have enabled reconstruction of highly detailed volumetric video representations or natural scenes. Infrared, lasers, time-of-flight, and structured light are all examples of devices that can be used to construct 3D video data. Representation of the 3D data depends on how the 3D data is used. Dense Voxel arrays have been used to represent volumetric medical data. In 3D graphics, polygonal meshes are extensively used. Point clouds on the other hand are well suited for applications such as capturing real world 3D scenes where the topology is not necessarily a 2D manifold. Another way to represent 3D data is coding this 3D data as set of texture and depth map as is the case in the multi-view plus depth. Closely related to the techniques used in multi-view plus depth is the use of elevation maps, and multi-level surface maps.

In the following, a short reference of ISO/IEC 23090-5 Visual Volumetric Video-based Coding (V3C) and Video-based Point Cloud Compression (V-PCC) 2nd Edition is given. Visual volumetric video comprising a sequence of visual volumetric frames, if uncompressed, may be represented by a large amount of data, which can be costly in terms of storage and transmission. This has led to the need for a high coding efficiency standard for the compression of visual volumetric data.

Visual volumetric video-based Coding (V3C) relates to a core part shared between ISO/IEC 23090-5 (formerly V-PCC (Video-based Point Cloud Compression)) and ISO/IEC 23090-12 (formerly MIV (MPEG Immersive Video)). V3C will not be issued as a separate document, but as part of ISO/IEC 23090-5 (expected to include clauses 1-8 of the current V-PCC text). ISO/IEC 23090-12 will refer to this common part. ISO/IEC 23090-5 will be renamed to V3C PCC, ISO/IEC 23090-12 renamed to V3C MIV.

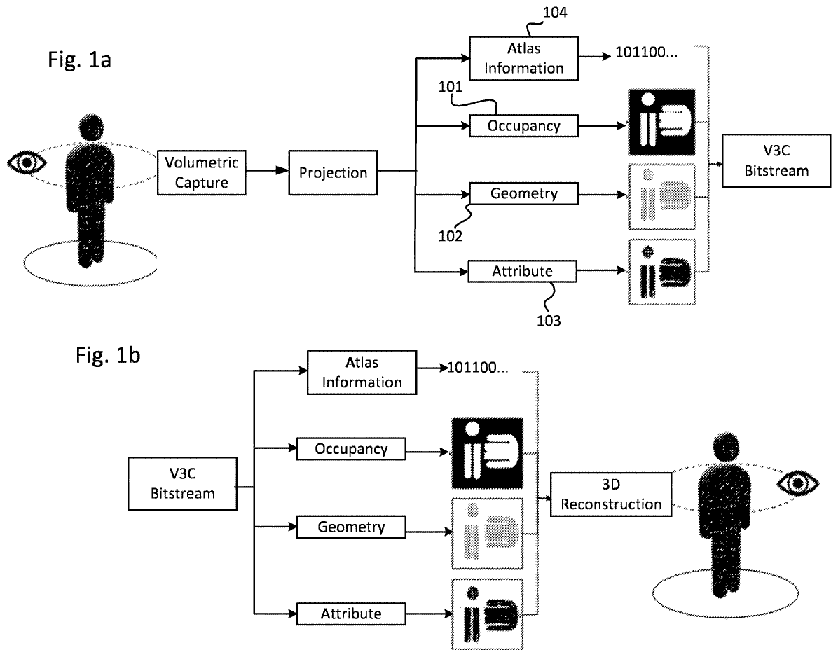

V3C enables the encoding and decoding processes of a variety of volumetric media by using video and image coding technologies. This is achieved through first a conversion of such media from their corresponding 3D representation to multiple 2D representations, also referred to as V3C video components, before coding such information. Such representations may include occupancy, geometry, and attribute components. The occupancy component can inform a V3C decoding and/or rendering system of which samples in the 2D components are associated with data in the final 3D representation. The geometry component contains information about the precise location of 3D data in space, while attribute components can provide additional properties, e.g., texture or material information, of such 3D data. An example is shown in FIGS. 1a and 1b, where FIG. 1a presents volumetric media conversion at an encoder, and where FIG. 1b presents volumetric media reconstruction at a decoder side. The 3D media is converted to a series of 2D representations: occupancy 101, geometry 102, and attributes 103. Additional information may also be included in the bitstream to enable inverse reconstruction.

Additional information that allows associating all these V3C video components and enables the inverse reconstruction from a 2D representation back to a 3D representation is also included in a special component, referred to in this document as the atlas 104. An atlas 104 may consist of multiple elements, named as patches. Each patch identifies a region in all available 2D components and contains information necessary to perform the appropriate inverse projection of this region back to the 3D space. The shape of such regions is determined through a 2D bounding volume associated with each patch as well as their coding order. The shape of these regions is also further refined after the consideration of the occupancy information.

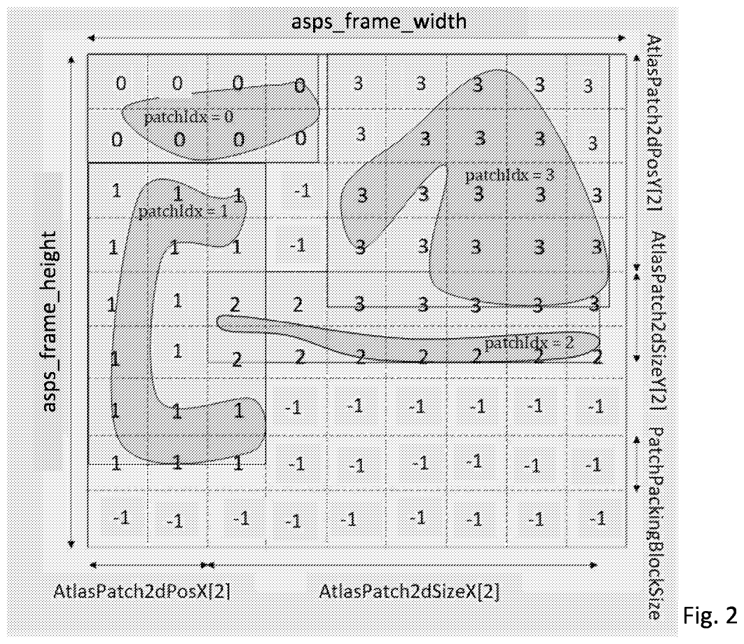

Atlases may be partitioned into patch packing blocks of equal size. The 2D bounding volumes of patches and their coding order determine the mapping between the blocks of the atlas image and the patch indices. FIG. 2 shows an example of block to patch mapping with 4 projected patches onto an atlas when asps_patch_precedence_order_flag is equal to 0. Projected points are represented with dark grey. The area that does not contain any projected points is represented with light grey. Patch packing blocks are represented with dashed lines. The number inside each patch packing block represents the patch index of the patch to which it is mapped.

Axes orientations are specified for internal operations. For instance, the origin of the atlas coordinates is located on the top-left corner of the atlas frame. For the reconstruction step, an intermediate axes definition for a local 3D patch coordinate system is used. The 3D local patch coordinate system is then converted to the final target 3D coordinate system using appropriate transformation steps.

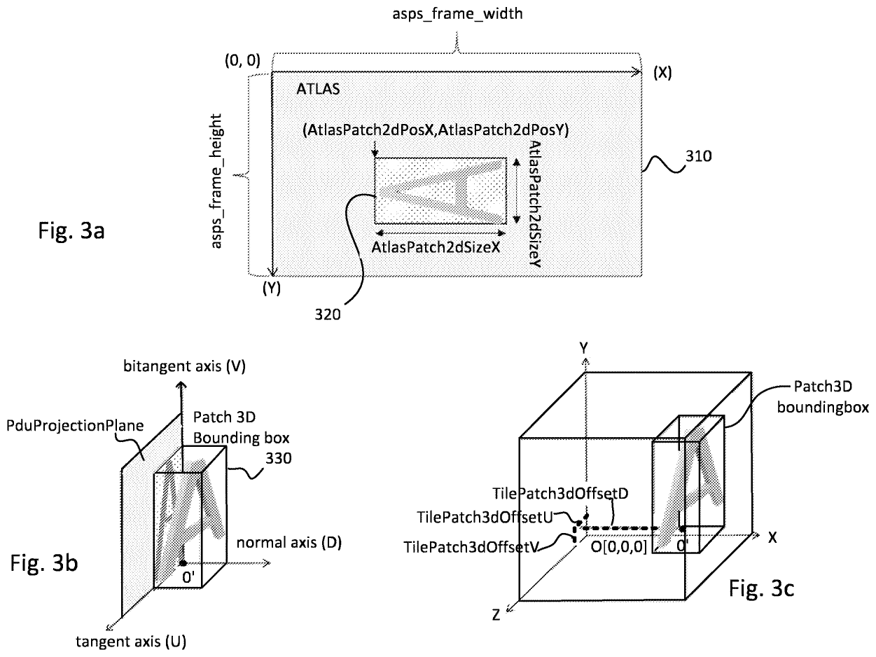

FIG. 3a shows an example of a single patch 320 packed onto an atlas image 310. This patch 320 is then converted to a local 3D patch coordinate system (U, V, D) defined by the projection plane with origin o′, tangent (U), bi-tangent (V), and normal (D) axes. For an orthographic projection, the projection plane is equal to the sides of an axis-aligned 3D bounding volume 330, as shown in FIG. 3b. The location of the bounding volume 330 in the 3D model coordinate system, defined by a left-handed system with axes (X, Y, Z), can be obtained by adding offsets TilePatch3dOffsetU, TilePatch3DOffsetV, and TilePatch3DOffsetD, as illustrated in FIG. 3c.

Coded V3C video components are referred to in this disclosure as video bitstreams, while a coded atlas is referred to as the atlas bitstream. Video bitstreams and atlas bitstreams may be further split into smaller units, referred to here as video and atlas sub-bitstreams, respectively, and may be interleaved together, after the addition of appropriate delimiters, to construct a V3C bitstream.

V3C patch in atlas bitstream, information is contained atlas_sub_bitstream( ), which contains a sequence of NAL units. NAL unit is specified to format data and provide header information in a manner appropriate for conveyance on a variety of communication channels or storage media. All data are contained in NAL units, each of which contains an integer number of bytes. A NAL unit specifies a generic format for use in both packet-oriented and bitstream systems. The format of NAL units for both packet-oriented transport and sample streams is identical except that in the sample stream format specified in Annex D of ISO/IEC 23090-5 each NAL unit can be preceded by an additional element that specifies the size of the NAL unit.

NAL units in atlas bitstream can be divided to atlas coding layer (ACL) and non-atlas coding layer (non-ACL) units. The former dedicated to carry patch data while the later to carry data necessary to properly parse the ACL units or any additional auxiliary data.

In the nal unit_header( ) syntax nal_unit_type specifies the type of the RBSP (Raw Byte Sequence Payload) data structure contained in the NAL unit as specified in Table 4 of ISO/IEC 23090-5. nal_layer_id specifies the identifier of the layer to which an ACL NAL unit belongs or the identifier of a layer to which a non-ACL NAL unit applies. The value of nal_layer_id shall be in the range of 0 to 62, inclusive. The value of 63 may be specified in the future by ISO/IEC. Decoders conforming to a profile specified in Annex A of ISO/IEC 23090-5 shall ignore (i.e., remove from the bitstream and discard) all NAL units with values of nal_layer_id not equal to 0.

V3C has been designed to be extensible to ensure that the first implementations of V3C decoders are compatible with any future extension. For that a number of fields for future extensions to parameter sets were reserved.

For example, second edition of V3C introduced an extension in VPS related to MIV and packed video component.

| | |
|---|---|
| ... | |
| vps_extension_present_flag | u(1) |
| if( vps_extension_present_flag ) { | |
| vps_packing_information_present_flag | u(1) |
| vps_miv_extension_present_flag | u(1) |
| vps_extension_6bits | u(6) |
| } | |
| if( vps_packing_information_present_flag ) { | |
| for( k = 0 ; k <= vps_atlas_count_minus1; k++ ) { | |
| j = vps_atlas_id[ k ] | |
| vps_packed_video_present_flag[ j ] | |
| if( vps_packed_video_present_flag[ j ] ) | |
| packing_information( j ) | |
| } | |
| } | |
| if( vps_miv_extension_present_flag ) | |
| vps_miv_extension( ) /*Specified in ISO/IEC 23090-12¹ */ | |
| if( vps_extension_6bits ) { | |
| vps_extension_length_minus1 | ue(v) |
| for(j = 0; j < vps_extension_length_minus1 + 1; j++ ) { | |
| vps_extension_data_byte | u(8) |
| } | |
| } | |
| byte alignment( ) | |
| } | |

A polygon mesh is a collection of vertices, edges and faces that defines the shape of a polyhedral object in 3D computer graphics and solid modelling. The faces usually consist of triangles (triangle mesh), quadrilaterals (quads), or other simple convex polygons (n-gons), since this simplifies rendering, but may also be more generally composed of concave polygons, or even polygons with holes. Objects created with polygon meshes are represented by different types of elements. These include vertices, edges, faces, polygons, and surfaces. In many applications, only vertices, edges and either faces or polygons are stored.

Polygon meshes are defined by the following elements:
Vertex: A position in 3D space defined as (x, y, z) along with other information such as color (r, g, b), normal vector and texture coordinates.
Edge: A connection between two vertices.
Face: A closed set of edges, in which a triangle face has three edges, and a quad face has four edges. A polygon is a coplanar set of faces. In systems that support multi-sided faces, polygons and faces are equivalent. Mathematically a polygonal mesh may be considered an unstructured grid, or undirected graph, with additional properties of geometry, shape and topology.
Surfaces: or smoothing groups, are useful, but not required to group smooth regions.
Groups: Some mesh formats contain groups, which define separate elements of the mesh, and are useful for determining separate sub-objects for skeletal animation or separate actors for non-skeletal animation.
Materials: defined to allow different portions of the mesh to use different shaders when rendered.
UV coordinates: Most mesh formats also support some form of UV coordinates which are a separate 2D representation of the mesh “unfolded” to show what portion of a 2-dimensional texture map applies to different polygons of the mesh. It is also possible for meshes to contain other vertex attribute information such as color, tangent vectors, weight maps to control animation, etc. (sometimes also called channels).

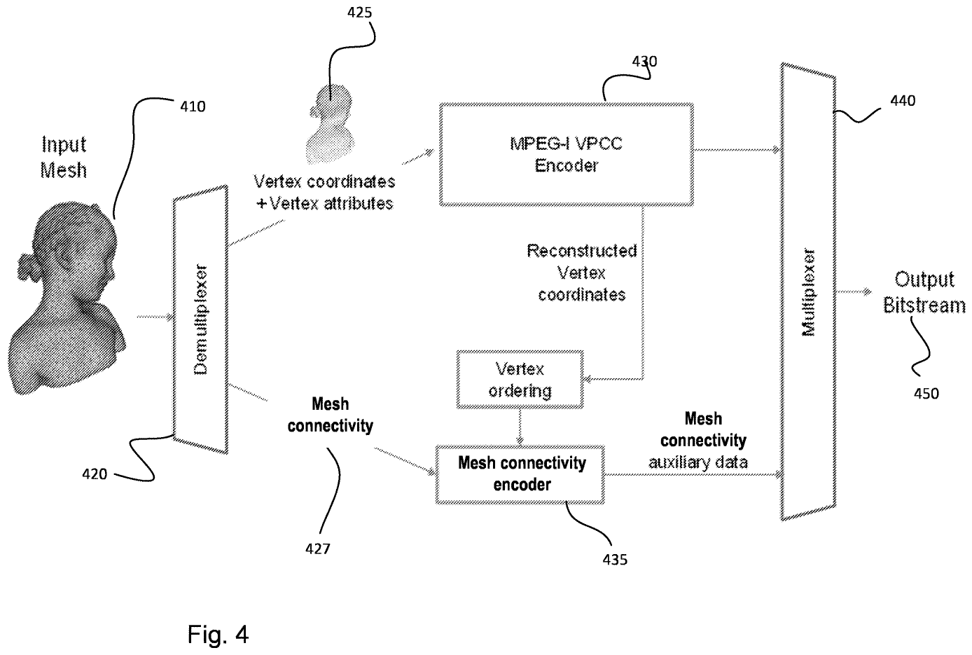

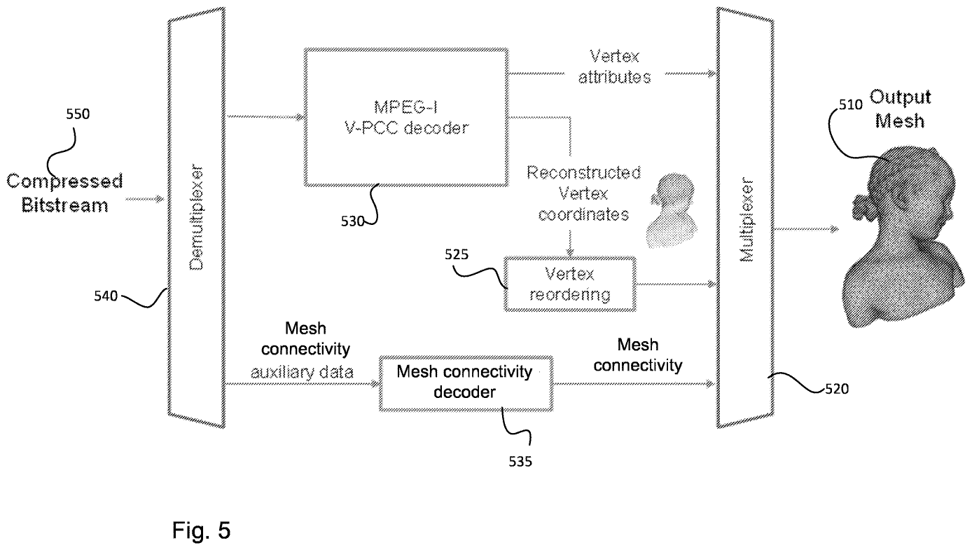

FIG. 4 and FIG. 5 show the extensions to the V3C encoder and decoder to support mesh encoding and mesh decoding, respectively.

In the encoder extension, shown in FIG. 4, the input mesh data 410 is demultiplexed 420 into vertex coordinate and attributes data 425 and mesh connectivity 427, where the mesh connectivity comprises vertex connectivity information. The vertex coordinate and attributes data 425 is coded using MPEG-IV-PCC 430, whereas the mesh connectivity data 427 is coded in mesh connectivity encoder 435 as auxiliary data. Both of these are multiplexed 440 to create the final compressed output bitstream 450. Vertex ordering is carried out on the reconstructed vertex coordinates at the output of MPEG-I V-PCC to reorder the vertices for optimal mesh connectivity encoding.

At the decoder, shown in FIG. 5, the input bitstream 550 is demultiplexed 540 to generate the compressed bitstreams for vertex coordinates and attributes data, as well as for mesh connectivity. The vertex coordinates and attributes data are decompressed using MPEG-I V-PCC decoder 530. Vertex reordering 525 is carried out on the reconstructed vertex coordinates at the output of MPEG-I V-PCC decoder 530 to match the vertex order at the encoder. Mesh connectivity data is decompressed using mesh connectivity decoder 535. The decompressed data is multiplexed 520 to generate the reconstructed mesh 510.

Mesh data can be compressed directly without projecting it to 2D planes, like in V-PCC based mesh coding. In fact, the anchor for V-PCC mesh compression call for proposals (CfP) utilizes off-the shelf mess compression technology, Draco for compressing mesh data excluding textures. Draco is used to compress vertex positions in 3D, connectivity data (faces) as well as UV coordinates. Additional per-vertex attributes may also be compressed using Draco. The actual UV texture may be compressed using traditional video compression technologies, such as H.265 or H.264.

An edgebreaker is an algorithm for efficient compression of 3D meshes. The edgebreaker encodes the connectivity of the triangle meshes. Because of the performance and simplicity of edgebreaker, it has been adopted in popular compression libraries.

Draco uses the edgebreaker algorithm at its core to compress 3D mesh information. It offers a good balance between simplicity and efficiency and is part of Khronos endorsed extensions for the gITF specification. The main idea of the algorithm is to traverse mesh triangles in a deterministic way so that each new triangle is encoded next to an already encoded triangle. This enables prediction of vertex specific information from the previously encoded data by simply adding delta to the previous data. Edgebreaker utilizes symbols to signal how each new triangle is connected to the previously encoded part of the mesh. Connecting triangles in such a way results on average in 1 to 2 bits per triangle when combined with existing binary encoding techniques.

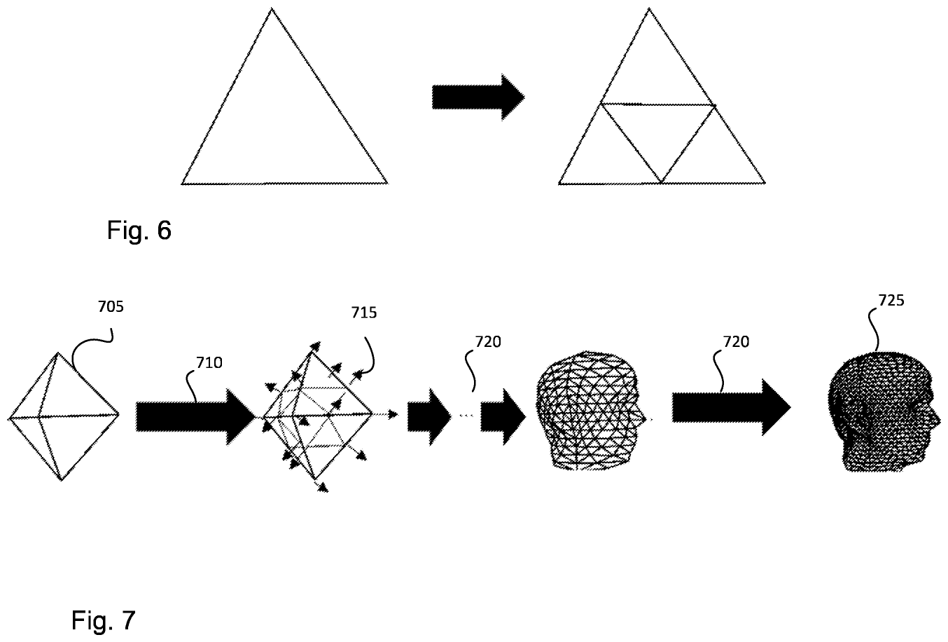

Standardization works for Video-based dynamic mesh coding (ISO/IEC 23090-29: V-DMC) standardization works have started after the completion of the call for proposal (CfP) issued by MPEG 3DG (ISO/IEC SC29 WG 2) on integration of MESH compression into the V3C family of standards (ISO/IEC 23090-5). The retained technology after the CfP result analysis is based on multiresolution mesh analysis and coding. The input data of the V-DMC framework is a texture mesh sequence. The texture mesh sequence contains frames (or interchangeably “mesh frames” or “temporal frames”) consisting of a textured mesh (i.e., a mesh with a set of vertices with geometry information and triangles) and a texture map (or interchangeably “attribute map”). The texture map comprises 2D texture/attribute coordinates associated to vertices and a texture/attribute image/frame. The texture coordinate of a vertex instructs what pixel (or interpolated pixel) of the texture image/frame should be used to “color” the vertex of the mesh. A normal vector is also associated to each vertex, to indicate the orientation of the surface around this vertex. The process may in general comprise the following:
generating a base mesh that is a simplified (low resolution) mesh approximation of the original mesh, called base mesh (this may be done for all frames of the dynamic mesh sequence) mᵢ
generating a reconstructed base mesh by encoding, decoding, and reconstructing the base mesh in the encoder;
performing several mesh subdivision iterative steps (e.g., each triangle is converted into four triangles by connecting the triangle edge midpoints as illustrated on FIG. 6) on the reconstructed base mesh, generating other approximation meshes mⁿᵢ where n stands for the number of iterations with mᵢ=m⁰ᵢ. The output of this process is a subdivided mesh. Each subdivision generates a level-of-detail (LOD), which means that the subdivided mesh representation contains different hierarchical levels (LODs) with LOD_0 corresponding to the base mesh, LOD_1 to the result of applying one iteration of subdivision to the reconstructed base mesh, etc.
fitting the subdivided mesh to the original input base mesh.
based on the fitting, defining displacement vectors di, also named error vectors, for each vertex of each mesh approximation mⁿᵢ with n>0, noted dⁿᵢ. The displacement vector corresponds to the shortest distance between the subdivided mesh vertex and the original mesh surface.
For each subdivision level, the deformed mesh (or a displaced subdivided mesh), obtained by mⁿᵢ+dⁿᵢ, i.e., by adding the displacement vectors to the subdivided mesh vertices generates the best approximation of the original mesh at that resolution, given the base mesh and prior subdivision levels.
The displacement vectors may undergo a lazy wavelet transform prior to compression.
The attribute map of the original mesh is transferred to the deformed mesh at the highest resolution (i.e., subdivision level) such that texture coordinates are obtained for the deformed mesh and a new attribute map is generated.

In the case the mesh frame is encoded in INTER mode, a fitting is performed between the base mesh of the current frame and the base mesh of the reference frame. It means that for each vertex of the current base mesh frame, a motion vector will be estimated with respect to the corresponding vertex of the reference base mesh. The V-DMC encoder may then apply the motion vectors to the reference base mesh and then applies the subdivision process as explained above.

It is also possible to let the encoder to decide to avoid both simplification and subdivision steps and consider the input mesh frame as the base mesh frame. Motion vectors are estimated in the INTER mode for each vertex as explained above, but no subdivision step, nor LOD level, nor displacement vectors are generated in such case.

An example of a multi-resolution analysis of a mesh is illustrated in FIG. 7. A base mesh 705 undergoes a first step of subdivision 710 and error vectors 715 are added to each vertex. After a series of subdivision and displacements 720, the highest resolution mesh 725 is generated. The connectivity of the highest resolution deformed mesh is generally different from the original mesh; however, the geometry of the deformed mesh is a good approximation of the original mesh geometry.

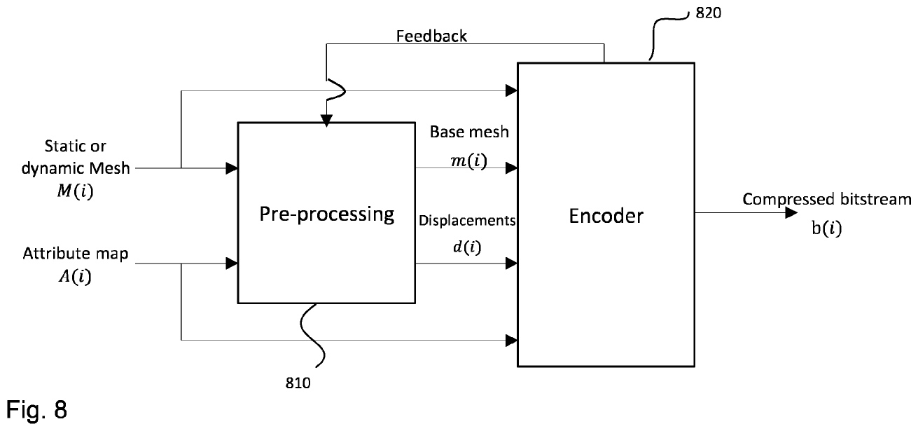

The encoding process can be separated into two main modules: the pre-processing module and the actual encoder module as illustrated on FIG. 8. The pre-processing module 810 generates a base mesh and the displacement vectors (also referred to as “displacement coefficients”), given the input mesh sequence and its attribute maps. The encoder module 820 generates the compressed bitstream by ingesting the inputs and outputs of the pre-processing module.

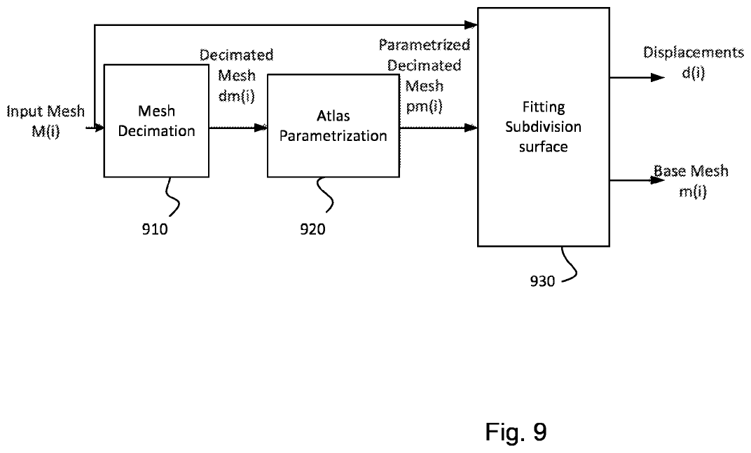

FIG. 9 illustrates an example of basic pre-processing steps: decimation 910 (reducing the original mesh resolution to produce a base mesh), uv-atlas isocharting 920 (creating a parameterization of the base mesh) and the subdivision surface fitting 930.

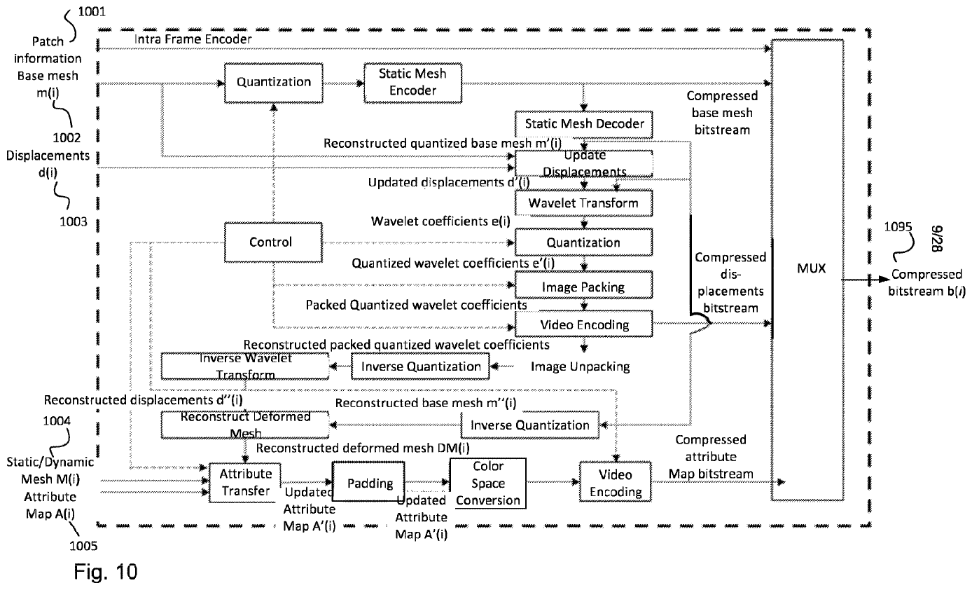

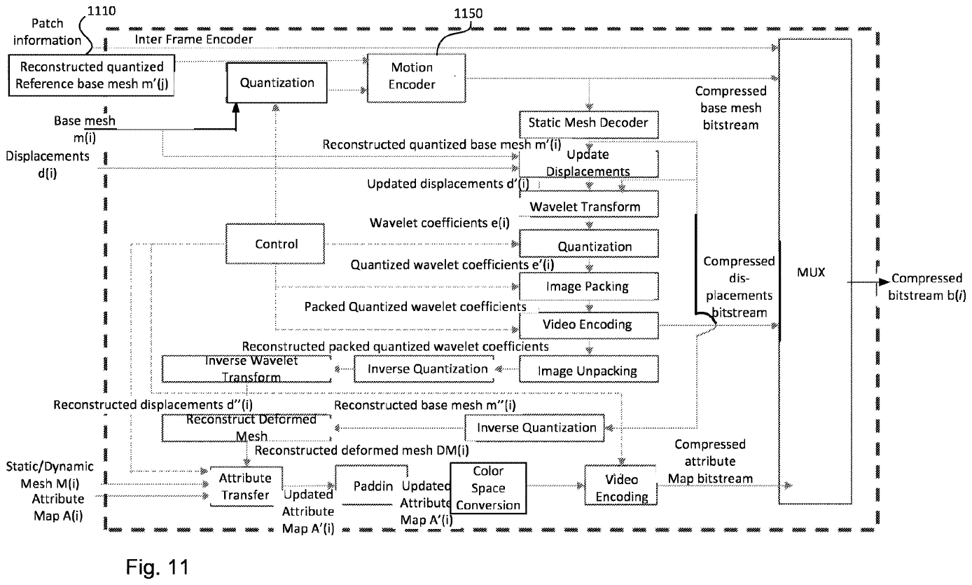

An example of an intra frame encoder is illustrated on FIG. 10, and an example of an inter frame encoder is illustrated on FIG. 11. In FIG. 11, the base mesh connectivity of the first frame of a group of frames is imposed to the subsequent frame's base meshes to improve compression performance.

The encoder process for intra frame encoding of FIG. 10 is described in more detailed manner. Inputs to the intra frame encoder are the base mesh 1002 (that is an approximation of the input mesh but that contains less faces and vertices), the patch information 1001 related to the input base mesh 1002, the displacement vectors 1003, the static/dynamic input mesh frame 1004 and the attribute map 1005. Outputs of the intra frame encoder is a compressed bitstream 1095 that contains a V3C extended signalling sub-bitstream including patch data information, compressed base mesh sub-bitstream, a compressed displacement video component sub-bitstream and a compressed Attribute video component sub-bitstream. The intra frame encoder takes the input base mesh and first quantize its data in the Quantization module, which can be dynamically tuned by a Control Module. The quantized base mesh is then encoded with the static mesh encoder module, which outputs a compressed base mesh sub-bitstream that is multiplexed in the output bitstream. The encoded base mesh is decoded in the Static Mesh Decoder module that generates a reconstructed quantized base mesh. The Update Displacements module takes as input the reconstructed quantized base mesh, the pristine base mesh and the input displacement vectors to generate new updated displacement vectors that are remapped to the reconstructed base mesh data in order to avoid precision errors due to the static mesh encoding and decoding process. The updated displacement vectors are filtered with a wavelet transform in the Wavelet Transform module (that also takes as input the reconstructed base mesh) and then quantized in the Quantization module. The Wavelet Transform aims to reduce the redundancy of the displacement vectors so that they can be efficiently predicted based on their neighbours.

The quantized wavelet coefficients produced from the updated displacements are then packed into a video component in the Image Packing module. This video component is then encoded with a 2D video encoder such as HEVC, VVC, etc., in the Video Encoder module, and the output compressed displacement video component sub-bitstream is multiplexed along with the V3C signalling information sub-bitstream into the output compressed bitstream. Then the compressed displacement video component is first decoded and reconstructed and then unpacked into encoded and quantized wavelet coefficients in the Image Unpacking module. These wavelet coefficients are then unquantized in the inverse quantization module and reconstructed with the inverse wavelet transform module that generates reconstructed displacements. The reconstructed base mesh is unquantized in the inverse quantization module and the unquantized base mesh is combined with the reconstructed displacements in the Reconstruct Deformed Mesh module to obtain the reconstructed deformed mesh. This reconstructed deformed mesh is then fed into the Attribute Transfer module together with the Attribute map produced by the pre-processing and the input static/dynamic mesh frame. The output of the Attribute Transfer module is an updated attribute map that now corresponds to the reconstructed deformed mesh frame. The updated attribute map is then padded, undergoes color conversion, and is encoded as a video component with a 2D video codec such as HEVC or VVC, in the Padding, Color Conversion and Video encoder modules respectively. The output compressed attribute map bitstream is multiplexed into the encoder output bitstream.

FIG. 11 illustrates an example of inter frame encoder. The inter encoding process is similar to the intra encoding process of FIG. 10 with the following changes. The reconstructed quantized reference base mesh 1110 is an input of the inter coding process. A module called Motion Encoder 1150 takes as input the quantized input base mesh and the reconstructed quantized reference base mesh 1110 to produce compressed motion information encoded as a compressed motion bitstream, which is multiplexed into the encoder output compressed bitstream. All other modules and processes are similar to the intra encoding case of FIG. 10.

The compressed bitstream generated by the encoder multiplexes:
A sub-bitstream with the encoded base mesh using a static mesh codec;
A sub-bitstream with the encoded motion data using an animation codec for base meshes in case INTER coding is enabled;
A sub-bitstream with the wavelet coefficients being generated by applying wavelet transform to the displacement vectors, the wavelet coefficients being packed in an image and encoded using a video codec;
A sub-bitstream with the attribute map encoded using a video codec;
A sub-bitstream that contains all metadata required to decode and reconstruct the mesh sequence based on the aforementioned sub-bitstreams. The signalling of the metadata is based on the V3C syntax and includes necessary extensions that are specific to meshes.

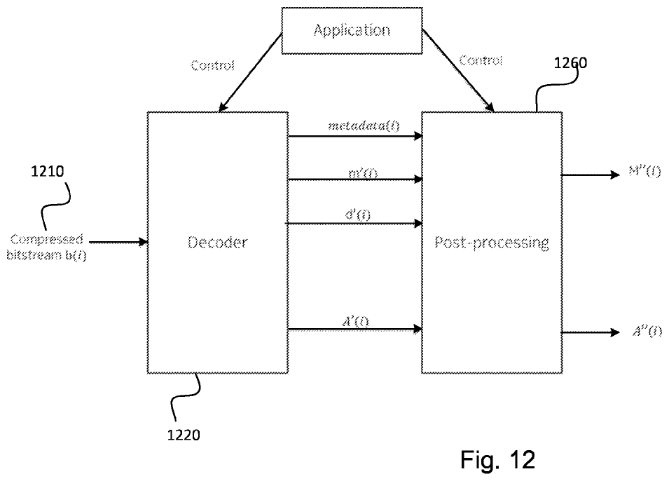

The decoding process is illustrated on FIG. 12. The decoding process comprises a decoder module 1220 that demultiplexes the compressed bitstream 1210 sub-bitstreams that are reconstructed, i.e., metadata, reconstructed base mesh, reconstructed displacements, and the reconstructed attribute map data. The reconstruction of the dynamic mesh sequence is performed based on that data in the post-processing module 1260.

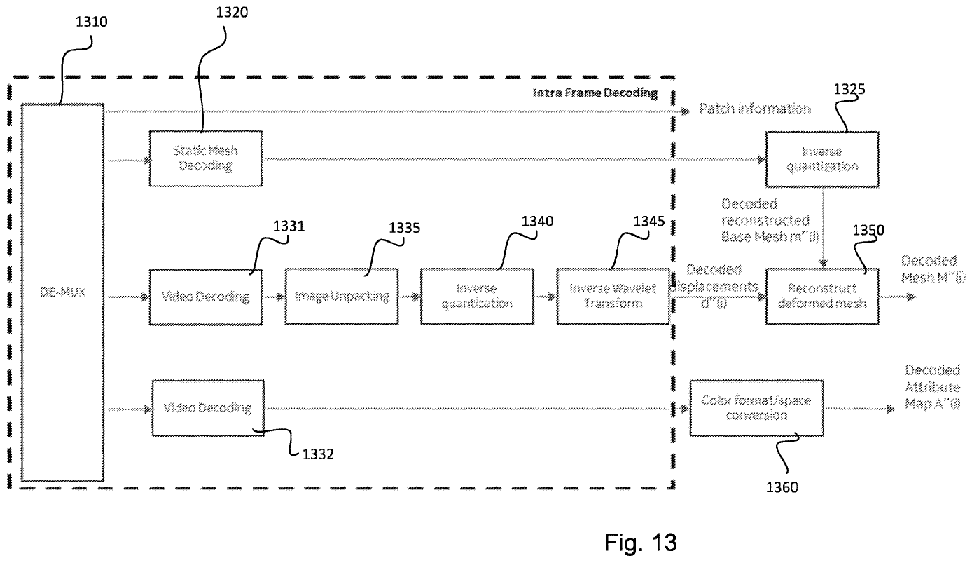

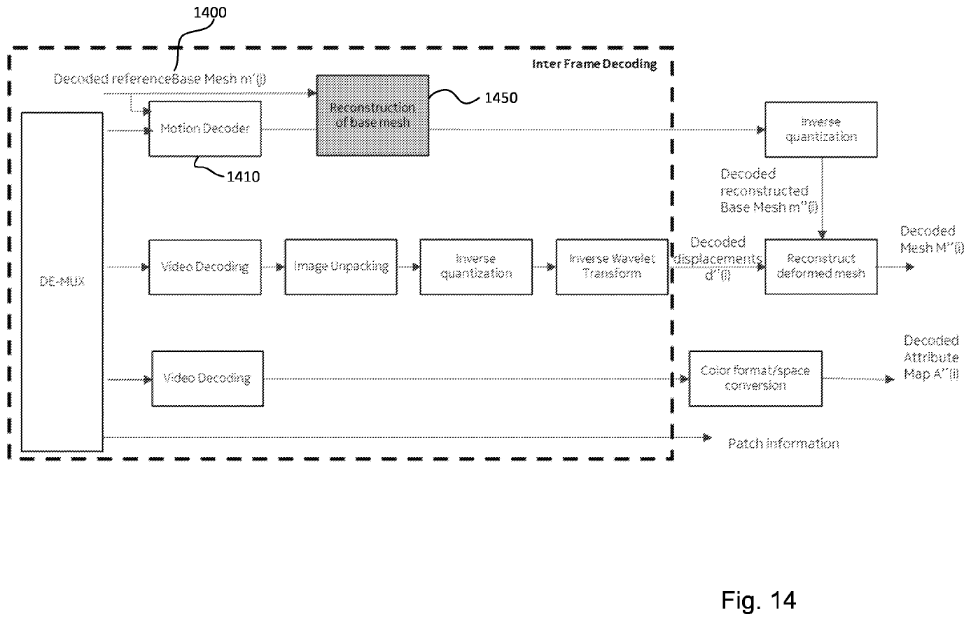

FIG. 13 illustrates an example of decoding process in intra mode, and FIG. 14 illustrates the decoding process in inter mode.

The intra frame decoding process according to FIG. 13, consists in the following modules and processes. First the input compressed bitstream is de-multiplexed 1310 into V3C extended atlas data information (or patch information), a compressed static mesh bitstream, a compressed displacement video component and a compressed attribute map bitstream, respectively. The static mesh decoding module 1320 converts the compressed static mesh bitstream into a reconstructed quantized static mesh, which represents a base mesh. This reconstructed quantized base mesh undergoes inverse quantization in the inverse quantization module 1325 to produce a decoded reconstructed base mesh.

The compressed displacement video component bitstream is decoded in the video decoding module 1331 to generate a reconstructed displacement video component. This reconstructed displacement video component is unpacked into reconstructed quantized wavelet coefficients in the image unpacking module 1335. Reconstructed quantized wavelet coefficients are inverse quantized in the inverse quantization module 1340 and then undergo an inverse wavelet transform in the inverse wavelet transform module 1345, that produces decoded displacement vectors. The reconstruct deformed mesh module 1350 takes into account the patch information and takes as input the decoded reconstructed base mesh and decoded displacement vectors to produce the output decoded mesh frame. The compressed attribute map video component is decoded at video coding module 1332, and optionally undergoes color conversion 1360 to produce a decoded attribute map frame that corresponds to the decoded mesh frame.

The inter decoding process of FIG. 14 is similar to the intra decoding process of FIG. 13 with the following changes. The decoder also demultiplexes a compressed information bitstream. A decoded reference base mesh is taken as input of a motion decoder module 1410 together with the compressed motion information sub-bitstream. This decoded reference base mesh is selected from a buffer of previously decoded base mesh frames (by the intra decoder process for the first frame of a group of frames). The reconstruction of base mesh module 1450 takes the decoded reference base mesh and the decoded motion information as input to produce a decoded reconstructed quantized base mesh. All other processes are similar to the intra decoding process of FIG. 13.

The signalling of the metadata and sub-bitstreams produced by the encoder and ingested by the decoder was proposed as an extension of V3C in the technical submission to the dynamic mesh coding CfP and should be considered as purely indicative for the moment. It is as follows and mainly consists in additional V3C unit header syntax, additional V3C unit payload syntax, and Mesh Intra patch data unit.

### V3C Unit Header Syntax:

| | Descriptor |
|---|---|
| v3c_unit_header( ) { | |
| vuh_unit_type | u(5) |
| if( vuh_unit_type == V3C_AVD \|\| vuh_unit_type == | |
| V3C_GVD \|\| | |
| vuh_unit_type == V3C_OVD \|\| vuh_unit_type == | |
| V3C_AD \|\| vuh_unit_type == V3C_MD) { | |
| vuh_v3c_parameter_set_id | u(4) |
| vuh_atlas_id | u(6) |
| } | |
| ... | |
| else if( vuh_unit_type==V3C_MD ) { | |
| vuh_mesh_data_sample_stream_flag | u(1) |
| vuh_mesh_data_motion_field_present_flag | u(1) |
| vuh_reserved_zero_15bits | u(15) |
| } | |
| Else | |
| vuh_reserved_zero_27bits | |
| } | |

### V3C Unit Payload Syntax:

Descriptor

```
v3c_unit_payload( numBytesInV3CPayload ) {
  if( vuh_unit_type == V3C_VPS )
    v3c_parameter_set( numBytesInV3CPayload )
  else if( vuh_unit_type == V3C_AD)
    atlas_sub_bitstream( numBytesInV3CPayload )
  else if( vuh_unit_type == V3C_MD)
    mesh_sub_bitstream( numBytesInV3CPayload)
  else if( vuh_unit_type == V3C_OVD ||
    vuh_unit_type == V3C_GVD ||
    vuh_unit_type == V3C_AVD)
    video_sub_bitstream( numBytesInV3CPayload )
}
```

### Mesh Intra Patch Data Unit:

| | Descriptor |
|---|---|
| mesh_intra_patch_data_unit( tileID, patchIdx ) { | |
| mdu_patchgroup_index[ tileID ][ patchIdx ] | ue(v) |
| mdu_patch_parameters_enable_flag[ tileID ][patchIdx ] | u(1) |
| mdu_geometry_2d_pos_x[ tileID ][ patchIdx ] | ue(v) |
| mdu_geometry_2d_pos_y[ tileID ][ patchIdx ] | ue(v) |
| mdu_geometry_2d_size_x_minus1[ tileID ][ patchIdx ] | ue(v) |
| mdu_geometry_2d_size_y_minus1[ tileID ][ patchIdx ] | ue(v) |
| mdu_attributes_2d_pos_x[ tileID ][ patchIdx ] | ue(v) |
| mdu_attributes_2d_pos_y[ tileID ][ patchIdx ] | ue(v) |
| mdu_attributes_2d_size_x_minus1[ tileID ][ patchIdx ] | ue(v) |
| mdu_attributes_2d_size_y_minus1[ tileID ][ patchIdx ] | ue(v) |
| mdu_3d_offset_u[ tileID ][ patchIdx ] | ue(v) |
| mdu_3d_offset_v[ tileID ][ patchIdx ] | ue(v) |
| mdu_3d_offset_d[ tileID ][ patchIdx ] | ue(v) |
| if( asps_normal_axis_max_delta_value_enabled_flag ) | |
| mdu_3d_range_d[ tileID ][ patchIdx ] | ue(v) |
| mdu_vertex_count_minus1[ tileID ][ patchIdx ] | ue(v) |
| mdu_triangle_count_minus1[ tileID ][ patchIdx ] | ue(v) |
| mdu_head_vertex_index[ tileID ][ patchIdx ] | ue(v) |
| mdu_num_sequential_vertex_index[ tileID ][ patchIdx ] | ue(v) |
| for(v=0; v<= mdu_vertex_count_minus1- | |
| mdu_num_sequential_vertex_index; v++){ | |
| mdu_vertex_index_diff[ tileID ][ patchIdx ] | se(v) |
| } | |
| if( vmc_ext_direct_attribute_projection_enabled ) { | |
| mdu_projection_id[ tileID ][ patchIdx ] | u(v) |
| mdu_orientation_index[ tileID ][ patchIdx ] | u(v) |
| } | |
| if( afps_lod_mode_enabled_flag ) { | |
| mdu_lod_enabled_flag[ tileID ][ patchIdx ] | u(1) |
| if( mdu_lod_enabled_flag[ tileID ][ patchIdx ] > 0 ) { | |
| mdu_lod_scale_x_minus1[ tileID ][ patchIdx ] | ue(v) |
| mdu_lod_scale_y_idc[ tileID ][ patchIdx ] | ue(v) |
| } | |
| } | |
| if( mdu_patch_parameters_enable_flag ) { | |
| mdu_subdivision_enable_flag | u(1) |
| mdu_displacement_coordinate_system_enable_flag | u(1) |
| mdu_transform_index_enable_flag | u(1) |
| mdu_transform_parameters_enable_flag | u(1) |
| mdu_num_attribute_enable_flag | u(1) |
| } | |
| if( mdu_subdivision_enable_flag ) { | |
| mdu_subdivision_method | ue(v) |
| mdu_subdivision_iteration_count_minus1 | ue(v) |
| } | |
| if( mdu_displacement_coordinate_system_enable_flag ) | |
| mdu_displacement_coordinate_system | ue(v) |
| if(mdu_transform_index_enable_flag) | |
| mdu_transform_index | ue(v) |
| if( mdu_transform_index != NONE && | |
| mdu_transform_parameters_enable_flag ) | |
| mdu_transform_parameters(0, | |
| mdu_transform_index) | |
| if( mdu_num_attribute_enable_flag ) | |
| mdu_num_attribute | ue(v) |
| for( i=0; i< mdu_num_attribute; i++ ){ | |
| mdu_attribute_type[ i ] | ue(v) |
| mdu_attribute_transform_index_enable_flag[ i ] | u(1) |
| mdu_attribute_transform_parameters_enable_flag[ i ] | u(1) |
| if(mdu_attribute_transform_index_enable_flag[ i ]) | |
| mdu_attribute_transform_index[ i ] | ue(v) |
| if(mdu_attribute_transform_index[ i ] != NONE && | |
| mdu_attribute_transform_parameters_enable_flag[ i ]) { | |
| mdu_transform_parameters(i+1, | |
| mdu_attribute_transform_index[ i ]) | |
| } | |
| } | |
| } | |

A refinement of the metadata and sub-bitstreams signaling is being discussed as proposed in [J. Kim, A. Tourapis, K. Mammou, D. Podborsky, D. Flynn, Support of the V3C framework in VDMC-TM, input document m60363, WG 07 MPEG 3D Graphics Coding and Haptics Coding, July 2022, Online] and is as follows.
Base meshes are the output of the base mesh sub-bitstream decoder.
A submesh is a set of vertices, their connectivity information being represented by levels of details, and the associated attributes which can be decoded completely independently in a mesh frame. Each base mesh can have one or more submeshes.
Resampled base meshes are the output of the mesh subdivision process. The inputs to the process is the base meshes (or sets of submeshes) as well the information from the atlas data sub-bitstream on how to subdivide/resample the meshes (submeshes).
A displacement video is the output of the displacement decoder. The inputs to the process are the decoded geometry video as well the information from the atlas data sub-bitstream on how to interpret/process this video. The displacement video contains displacement vectors (also known as displacement coefficients) to be added to the corresponding vertices.
A facegroupId is one of the attribute types assigned to each triangle face of the resampled base meshes. FacegroupId can be compared with the identifications of the subparts in a patch to determine the corresponding facegroups to the patch. If facegrould is not conveyed through the base mesh sub-bitstream decoder, it is derived by the information in the atlas data sub-bitstream.

Compressed base meshes are signaled in a new sub-bitstream, named as the Base Mesh data sub-bitstream (unit type V3C_MD). As with other v3c units, the unit type, and its associated v3c parameter set identification (id) and atlas identification are signaled in the v3c_unit_header( ).

| | Descriptor |
|---|---|
| v3c_unit_header( ) { | |
| vuh_unit_type | u(5) |
| if( vuh_unit_type == V3C_AVD \|\| vuh_unit_type == | |
| V3C_GVD \|\| | |
| vuh_unit_type == V3C_OVD \|\| vuh_unit_type == | |
| V3C_AD \|\| vuh_unit_type==V3C_MD) { | |
| vuh_v3c_parameter_set_id | u(4) |
| vuh_atlas_id | u(6) |
| } | |
| ... | |
| Else | |
| vuh_reserved_zero_27bits | u(27) |
| } | |

Descriptor

```
v3c_unit_payload( numBytesInV3CPayload ) {
  if( vuh_unit_type == V3C_VPS )
    v3c_parameter_set( numBytesInV3CPayload )
  else if( vuh_unit_type == V3C_AD)
    atlas_sub_bitstream( numBytesInV3CPayload )
  else if( vuh_unit_type == V3C_MD)
      mesh_sub_bitstream( numBytesInV3CPayload)
  else if( vuh_unit_type == V3C_OVD ||
vuh_unit_type == V3C_GVD ||
vuh_unit_type == V3C_AVD)
    video_sub_bitstream( numBytesInV3CPayload )
```

v3c_parameter_set syntax structure has an extension to handle V-DMC. Several new parameters are introduced in this extension, for example:
vps_ext_mesh_data_facegroup_id_attribute_present_flag equals 1 indicates that one of the attribute types present in the base mesh data stream is the facegroupId.
vps_ext_mesh_data_attribute_count indicates the number of total attributes in the base mesh including both the attributes signaled through the base mesh data sub-bitstream and the attributes signaled in the video sub streams (using ai_attribute_count). When vps_ext_mesh_data_facegroup_id_attribute_present_flag equals 1, it shall be greater or equal to ai_attribute_count+1. This can be constrained by profile/levels.
The types of attributes that are signaled through the base mesh sub-bitstream and not through the video sub-bitstreams are signaled are signaled as vps_ext_mesh_attribute_type data types. When vps_ext_mesh_data_facegroup_id_attribute_present_flag equals 1, one of the vps_ext_mesh_attribute_type must be a facegroupId.
vps_ext_mesh_data_substream_codec_id indicates the identifier of the codec used to compress the base mesh data. This codec may be identified through the profiles a component codec mapping SEI message, or through means outside this document.
vps_ext_attribute_frame_width[i] and vps_ext_attribute_frame_height[i] indicate the corresponding with and height of the video data corresponding to the i-th attribute among the attributes signaled in the video sub-bitstreams.

| | descriptor |
|---|---|
| vps_v3c_vmesh_extension ( numBytesInV3CPayload ) { | |
| for(j=0; j<altals_count_minus1+1; j++){ | |
| vps_ext_mesh_data_facegroup_id_attribute_present_flag[ j ] | u(1) |
| vps_ext_mesh_data_substream_codec_id[ j ] | ue(v) |
| vps_ext_mesh_data_attribute_count[ j ] | ue(v) |
| NumNonVideoAttribute=vps_ext_mesh_data_attribute_count[ j ]- | |
| ai_attribute_count[ j ] | |
| for( i = 0; i < vps_ext_mesh_data_attribute_count[ j ]; i++ ) | |
| vps_ext_mesh_attribute_bitdepth_minus1[ j ][ i ] | |
| for( i = 0; i <NumNonVideoAttribute ; i++ ) | |
| vps_ext_mesh_attribute_type[ j ][ i ] | ue(v) |
| for( i = 0; i < ai_attribute_count[ j ]; i++ ) { | |
| vps_ext_attribute_frame_width[ j ][ i ] | ue(v |
| vps_ext_attribute_frame_height[ j ][ i ] | ue(v) |
| } | |
| } | |
| } | |

Atlas sequence parameter set has extension, in which the information can be overwritten by the same information in the AFPS extension or the patch data units. The following parameters are introduced:
asps_vmc_ext_prevent_geometry_video_conversion_flag prevents the outputs of the geometry video sub-bitstream decoder from being converted. When the flag is true, the outputs are used as they are without any conversion process. When the flag is true, the size of geometry video shall be same as nominal video sizes indicated in the bitstream.
asps_vmc_ext_prevent_attribute_video_conversion_flag prevents the outputs of attribute video sub-bitstream decoder from being converted. When the flag is true, the outputs are used as they are without any conversion process. When the flag is true, the size of attribute video shall be same as nominal video sizes indicated in the bitstream.
asps_vmc_ext_subdivision_method and asps_vmc_ext_subdivision_iteration_count signal information about the subdivision method.

| asps_vmc_ext_subdivision_method | Name of subdivision method |
|---|---|
| 0 | MIDPOINT |

asps_vmc_ext_transform_index indicates the transform applied to the displacement. The transform index can indicate any transform is not applied. When the transform is LINEAR_LIFTING, the necessary parameters are signaled as vmc_lifting_transform_parameters.

| asps_vmc_ext_transform_index | Name of transform method |
|---|---|
| 0 | NONE |
| 1 | LINEAR_LIFTING |

asps_vmc_ext_patch_mapping_method indicates how to map a subpart of a submesh to a patch.
   When asps_vmc_ext_patch_mapping_method is equal to 0, all the triangles in the corresponding submesh are associated with the current patch. In this case, there is only one patch associated with the submesh.
   When asps_vmc_ext_patch_mapping method is equal to 1, the subpart_ids are explicitly signalled in the mesh patch data unit to indicate the associated subparts.
   In other cases, the triangle faces in the corresponding submesh are divided into subparts by the method indicated by asps_vmc_ext_patch_mapping_method.
asps_vmc_ext_tjunction_removing_method indicates the method to remove t-junctions created by different subdivision methods or by different subdivision iterations of two triangles sharing an edge.
asps_vmc_ext_num_attribute indicates the total number of attributes that the corresponding mesh carries. Its value shall be less or equal to vps_ext_mesh_data_attribute_count.
asps_vmc_ext_attribute_type is the type of the i-th attribute and it shall be one of ai_attribute_type_ids or vps_ext_mesh_attribute_types.
asps_vmc_ext_direct_atrribute_projection_enabled_flag indicates that the 2d locations where attributes are projected are explicitly signaled in the mesh patch data units. Therefore, the projection identification and orientation index in V3C V-PCC ISO/IEC 23090-5:2021 can be also used as in ISO/IEC 23090-5:2021.

| | Descriptor |
|---|---|
| asps_vmc_extension( ) { | |
| asps_vmc_ext_prevent_geometry_video_conversion_flag | u(1) |
| asps_vmc_ext_prevent_attribute_video_conversion_flag | u(1) |
| asps_vmc_ext_subdivision_method | u(3) |
| asps_vmc_ext_subdivision_iteration_count | u(8) |
| asps_vmc_ext_displacement_coordinate_system | u(1) |
| asps_vmc_ext_transform_index | u(3) |
| if(asps_vmc_ext_transform_index == LINEAR_LIFTING) { | |
| vmc_lifting_transform_parameters( 0, 0 ) | |
| } | |
| asps_vmc_ext_patch_mapping_method | ue(v) |
| asps_vmc_ext_tjunction_removing_method | ue(v) |
| asps_vmc_ext_num_attribute | ue(v) |
| asps_vmc_ext_num_attribute_video | u(7) |
| for(i=0; i< asps_vmc_ext_num_attribute; i++) | |
| asps_vmc_ext_attribute_bitdetph_minus1[ i ] | u(8) |
| NumAspsNonVideoAttribute= asps_vmc_ext_num_attribute - | |
| asps_vmc_ext_num_attribute_video | |
| for(i=0; i< NumAspsNonVideoAttribute i++) | |
| asps_vmc_ext_attribute_type[ i ] | u(8) |
| for(i=0; i< asps_vmc_ext_num_attribute_video; i++){ | |
| asps_vmc_ext_attribute_video_type[ i ] | u(8) |
| asps_vmc_ext_attribute_frame_width[ i ] | ue(v) |
| asps_vmc_ext_attribute_frame_height[ i ] | ue(v) |
| asps_vmc_vmc_ext_attribute_transform_index[ i ] | u(3) |
| if(asps_vmc_ext_attribute_transform_index == | |
| LINEAR_LIFTING ) { | |
| asps_vmc_extension_transform_parameters_present_flag[ i ] | u(1) |
| if(asps_vmc_extension_transform_parameters_present_flag) | |
| vmc_lifting_transform_parameters(i+1, 0) | |
| } | |
| asps_vmc_ext_direct_atrribute_projection_enabled_flag[ i ] | u(1) |
| } | |
| } | |

| | descriptor |
|---|---|
| vmc_lifting_transform_parameters( attributeIndex, ltpIndex ){ | |
| vmc_transform_lifting_skip_update[attributeIndex][ ltpIndex ] | u(1) |
| vmc_transform_lifting_quantization_parameters_x[attributeInd | ue(v) |
| ex][ ltpIndex ] | |
| vmc_transform_lifting_quantization_parameters_y[attributeInd | ue(v) |
| ex][ ltpIndex ] | |
| vmc_transform_lifting_quantization_parameters_z[attributeInd | ue(v) |
| ex][ ltpIndex ] | |
| vmc_transform_log2_lifting_lod_inverseScale_x[attributeIndex][ | ue(v) |
| ltpIndex ] | |
| vmc_transform_log2_lifting_lod_inverseScale_y[attributeIndex][ | ue(v) |
| ltpIndex ] | |
| vmc_transform_log2_lifting_lod_inverseScale_z[attributeIndex][ | ue(v) |
| ltpIndex ] | |
| vmc_transform_log2_lifting_update_weight[attributeIndex][ ltpI | ue(v) |
| ndex ] | |
| vmc_transform_log2_lifting_prediction_weight[attributeIndex][ | ue(v) |
| ltpIndex ] | |
| } | |

### Atlas Frame Parameter Set Extension

afps_vmc_ext_single_submesh_in_frame_flag indicates there is only one submesh for the mesh frame
When afps_vmc_ext_overriden_flag in afps_vmc_extension( ) is true, the subdivision method, displacement coordinate system, transform index, transform parameters, and attribute transform parameters can be signaled again and the information overrides the one signaled in asps_vmc_extension( ).
afps_vmc_ext_single_attribute_tile_in_frame_flag indicates there is only one tile for each attribute signaled in the video streams.

| | Descriptor |
|---|---|
| afps_vmc_extension( ) { | |
| afps_vmc_ext_single_submesh_in_frame_flag | u(1) |
| afps_vmc_ext_overriden_flag | u(1) |
| if(afps_vmc_ext_overriden_flag){ | |
| afps_vmc_ext_subdivision_enable_flag | u(1) |
| afps_vmc_ext_displacement_coordinate_system_enable_flag | u(1) |
| afps_vmc_ext_transform_index_enable_flag | u(1) |
| afps_vmc_ext_transform_parameters_enable_flag | u(1) |
| afps_vmc_ext_attribute_parameter_overwrite_flag | u(1) |
| } | |
| if(afps_vmc_ext_subdivision_enable_flag){ | |
| afps_vmc_ext_subdivision_method | u(3) |
| afps_vmc_ext_subdivision_iteration_count | u(8) |
| } | |
| if(afps_vmc_ext_displacement_coordinate_system_enable_flag) | |
| afps_vmc_ext_displacement_coordinate_system | u(1) |
| if(afps_vmc_ext_transform_index_enable_flag) | |
| afps_vmc_ext_transform_index | u(3) |
| if(afps_vmc_ext_transform_index == LINEAR_LIFTING && | |
| afps_vmc_ext_transform_parameters_enable_flag) | |
| vmc_lifting_transform_parameters( 0, 1 ) | |
| if(afps_vmc_ext_attribute_parameter_overwrite_flag){ | |
| for(i=0; i< asps_vmc_ext_num_attribute_video; i++){ | |
| afps_vmc_ext_direct_attribute_projection_enabled[ i ] | u(1) |
| afps_vmc_ext_attribute_transform_index_enable_flag[ i ] | u(1) |
| afps_vmc_ext_attribute_transform_parameters_enable_flag[ i | u(1) |
| ] | |
| if(afps_vmc_ext_attribute_transform_index_enable_flag[ i ]) | |
| afps_vmc_ext_attribute_transform_index[ i ] | u(3) |
| if(afps_vmc_ext_attribute_transform index == | |
| LINEAR_LIFTING && afps_vmc_ext_attribute_transform_{—} | |
| parameters_enable_flag) | |
| vmc_lifting_transform_parameters( i+1, 1) | |
| } | |
| } | |
| for(j=0; j< asps_vmc_ext_num_attribute_video; j++){ | |
| afps_vmc_ext_single_attribute_tile_in_frame_flag[ j ] | u(1) |
| if(!afps_vmc_ext_single_attribute_tile_in_frame_flag[ j ]) | |
| afps_ext_vmc_attribute_tile_information(j) | |
| } | |
| } | |

afps_ext_vmc_attribute_tile_information( ) contains the tile information for the attributes signaled through the video sub-bitstreams.

| | Descriptor |
|---|---|
| afps_ext_vmc_attribute_tile_information( videoAttribueId ) { | |
| afps_vmc_ext_attribute_ti_uniform_partition_spacing_flag[videoAt | u(1) |
| tribueId ] | |
| if( afps_vmc_ext_attribute_ti_uniform_partition_spacing_flag ) { | |
| afps_vmc_ext_attribute_ti_partition_cols_width_minus1[videoAttri | ue(v) |
| bueId ] | |
| afps_vmc_ext_attribute_ti_partition_rows_height_minus1[videoAttr | ue(v) |
| ibueId ] | |
| } else { | |
| afps_vmc_ext_attribute_ti_num_partition_columns_minus1[videoA | ue(v) |
| ttribueId ] | |
| afps_vmc_ext_attribute_ti_num_partition_rows_minus1[videoAttri | ue(v) |
| bueId ] | |
| for( i = 0; i < | |
| afps_vmc_ext_attribute_ti_num_partition_columns_minus1; i++ ) | |
| afps_vmc_ext_attribute_ti_partition_column_width_minus1[videoA | ue(v) |
| ttribueId ] [ i ] | |
| for( i = 0; i < afps_vmc_ext_attribute_ti_num_partition_rows_minus1; | |
| i++ ) | |
| afps_vmc_ext_attribute_ti_partition_row_height_minus1[videoAttri | ue(v) |
| bueId ] [ i ] | |
| } | |
| afps_vmc_ext_attribute_ti_single_partition_per_tile_flag[videoAttri | u(1) |
| bueId ] | |
| if( !afps_vmc_ext_attribute_ti_single_partition_per_tile_flag ) { | |
| afps_vmc_ext_attribute_ti_num_tiles_in_atlas_frame_minus1[video | ue(v) |
| AttribueId ] | |
| for( i = 0; i < | |
| afps_vmc_ext_attribute_ti_num_tiles_in_atlas_frame_minus1 + 1; i++ ) | |
| { | |
| afps_vmc_ext_attribute_ti_top_left_partition_idx[videoAttribueId ] | ue(v) |
| [ i ] | |
| afps_vmc_ext_attribute_ti_bottom_right_partition_column_offset[v | ue(v) |
| ideoAttribueId ] [ i ] | |
| afps_vmc_ext_attribute_ti_bottom_right_partition_row_offset[vide | ue(v) |
| oAttribueId ] [ i ] | |
| } | |
| } | |

### Atlas Tile Header:

A tile can be associated with one or more submeshes whose identification is ath_submesh_id.

| | Descriptor |
|---|---|
| atlas_tile_header( ) { | |
| ... | |
| if(!afps_vmc_ext_single_submesh_in_frame_flag){ | |
| ath_num_submesh | ue(v) |
| for( i = 0; i< ath_num_submesh; i++) | |
| ath_submesh_id | u(v) |
| } | |
| } | |

As with the V-PCC Patch data units, Mesh patch data units are signaled in the Atlas data sub-bitstream. Mesh Intra patch data unit, Mesh Inter patch data unit, Mesh Merge patch data unit, and Mesh Skip patch data unit can be used.

Descriptor

```
patch_information_data( tileID, patchIdx, patchMode ) {
  if( ath_type == P_TILE ) {
...
  else if( patchMode == I_MESH )
    mesh_intra_patch_data_unit( tileID, patchIdx )
  else if( patchMode == P_MESH )
    mesh_inter_patch_data_unit( tileID, patchIdx )
  else if( patchMode == M_MESH )
    mesh_merge_patch_data_unit( tileID, patchIdx )
  else if( patchMode == RAW_MESH )
    mesh_raw_patch_data_unit( tileID, patchIdx )
  }
  else if( ath_type == I_TILE ) {
...
  else if( patchMode == I_MESH )
    mesh_intra_patch_data_unit( tileID, patchIdx )
  else if( patchMode == RAW_MESH )
    mesh_raw_patch_data_unit( tileID, patchIdx )
  }
}
```

mdu_submesh_id indicate which submesh the patch is associated with among those indicated in the atlas tile header.
mdu_vertex_count_minus1 and mdu_triangle_count_minus1 indicate the number of vertices and triangles associated with the current patch.
When asps_vmc_ext_patch_mapping method is not 0, the syntax elements mdu_num_subparts and mdu_subpart_id are signaled. When asps_vmc_ext_patch_mapping_method is 1, the associated triangle faces are the union of the triangle faces whose facegroupId is equal to mdu_subpart_id.
When mdu_patch_parameters_enable_flag is true, the subdivision method, displacement coordinate system, transform index, transform parameters, and attribute transform parameters can be signaled again and the information overrides the corresponding information signaled in in asps_vmc_extension( ).

| | Descriptor |
|---|---|
| mesh_intra_data_unit( tileID, patchIdx ) { | |
| mdu_submesh_id[ tileID ][ patchIdx ] | u(v) |
| mdu_vertex_count_minus1[ tileID ][ patchIdx ] | ue(v) |
| mdu_triangle_count_minus1[ tileID ][ patchIdx ] | ue(v) |
| if(asps_vmc_ext_patch_mapping_method != 0){ | |
| mdu_num_subparts[ tileID ][ patchIdx ] | ue(v) |
| for(i=0;i< mdu_num_subparts[ tileID ][ patchIdx ]; i++) | |
| mdu_subpart_id[ tileID ][ patchIdx ] | ue(v) |
| } | |
| mdu_geometry_2d_pos_x[ tileID ][ patchIdx ] | ue(v) |
| mdu_geometry_2d_pos_y[ tileID ][ patchIdx ] | ue(v) |
| mdu_geometry_2d_size_x_minus1[ tileID ][ patchIdx ] | ue(v) |
| mdu_geometry_2d_size_y_minus1[ tileID ][ patchIdx ] | ue(v) |
| mdu_3d_offset_u[ tileID ][ patchIdx ] | ue(v) |
| mdu_3d_offset_v[ tileID ][ patchIdx ] | ue(v) |
| mdu_3d_offset_d[ tileID ][ patchIdx ] | ue(v) |
| if( asps_normal_axis_max_delta_value_enabled_flag ) | |
| mdu_3d_range_d[ tileID ][ patchIdx ] | ue(v) |
| if( afps_lod_mode_enabled_flag ) { | |
| mdu_lod_enabled_flag[ tileID ][ patchIdx ] | u(1) |
| if( mdu_lod_enabled_flag[ tileID ][ patchIdx ] > 0 ) { | |
| mdu_lod_scale_x_minus1[ tileID ][ patchIdx ] | ue(v) |
| mdu_lod_scale_y_idc[ tileID ][ patchIdx ] | ue(v) |
| } | |
| } | |
| mdu_patch_parameters_enable_flag[ tileID ][patchIdx ] | u(1) |
| if(mdu_patch_parameters_enable_flag){ | |
| mdu_subdivision_enable_flag[ tileID ][ patchIdx ] | u(1) |
| mdu_displacement_coordinate_system_enable_flag[ tileID ] | u(1) |
| [ patchIdx ] | |
| mdu_transform_index_enable_flag[ tileID ][ patchIdx ] | u(1) |
| mdu_transform_parameters_enable_flag[ tileID ][ patchIdx | u(1) |
| ] | |
| mdu_attribute_parameter_overwrite_flag[ tileID ][ patchId | u(1) |
| x ] | |
| } | |
| if(mdu_subdivision_enable_flag[ tileID ][ patchIdx ]){ | |
| mdu_subdivision_method[ tileID ][ patchIdx ] | u(3) |
| mdu_subdivision_iteration_count[ tileID ][ patchIdx ] | u(8) |
| } | |
| if(mdu_displacement_coordinate_system_enable_flag[ tileID ] | |
| [ patchIdx ]) | |
| mdu_displacement_coordinate_system[ tileID ][ patchIdx ] | u(1) |
| if(mdu_transform_index_enable_flag[ tileID ][ patchIdx ]) | |
| mdu_transform_index[ tileID ][ patchIdx ] | u(3) |
| if(mdu_transform_index[ tileID ][ patchIdx ] == | |
| LINEAR_LIFTING && | |
| mdu_transform_parameters_enable_flag[ tileID ][ patchIdx ]) | |
| vmc_lifting_transform_parameters(0, 2) | |
| for(i=0; i< asps_vmc_ext_num_attribute_video; i++){ | |
| mdu_vmc_ext_direct_attribute_projection_enabled | u(1) |
| [ tileID ][ patchIdx ][ i ] | |
| if(afps_vmc_ext_direct_attribute_projection_enabled | |
| [ tileID ][ patchIdx ][ i ]){ | |
| mdu_attributes_2d_pos_x[ tileID ][ patchIdx ][ i ] | ue(v) |
| mdu_attributes_2d_pos_y[ tileID ][ patchIdx ][ i ] | ue(v) |
| mdu_attributes_2d_size_x_minus1[ tileID ][ patchIdx ][ i ] | ue(v) |
| mdu_attributes_2d_size_y_minus1[ tileID ][ patchIdx ][ i ] | ue(v) |
| mdu_projection_id[ tileID ][ patchIdx ][ i ] | ue(v) |
| mdu_orientation_index[ tileID ][ patchIdx ][ i ] | ue(v) |
| } | |
| if(mdu_attribute_parameter_overwrite_flag[ tileID ][ patchIdx | |
| ]){ | |
| mdu_attribute_transform_index_enable_flag[ tileID ][ patc | u(1) |
| hIdx ][ i ] | |
| mdu_attribute_transform_parameters_enable_flag[ tileID ] | u(1) |
| [ patchIdx ][ i ] | |
| if(mdu_attribute_transform_index_enable_flag[ tileID ][ patchI | |
| dx ][ i ]) | |
| mdu_attribute_transform_index[ tileID ][ patchIdx ][ i ] | u(3) |
| if(mdu_attribute_transform_index[ tileID ][ patchIdx ] == | |
| LINEAR_LIFTING && mdu_attribute_transform_parameters | |
| _enable_flag[ tileID ][ patchIdx ]) | |
| vmc_lifting_transform_parameters(i+1, 2) | |
| }//if | |
| } | |
| } | |

| | Descriptor |
|---|---|
| mesh_inter_data_unit( tileID, patchIdx ) { | |
| if( NumRefIdxActive > 1 ) | |
| midu_ref_index[ tileID ][ patchIdx ] | ue(v) |
| midu_ref_patch_index[ tileID ][ patchIdx ] | se(v) |
| midu_vertex_count_delta[ tileID ][ patchIdx ] | se(v) |
| midu_triangle_count_delta[ tileID ][ patchIdx ] | se(v) |
| midu_geometry_2d_pos_x[ tileID ][ patchIdx ] | ue(v) |
| midu_geometry_2d_pos_y[ tileID ][ patchIdx ] | ue(v) |
| midu_geometry_2d_size_x_delta[ tileID ][ patchIdx ] | ue(v) |
| midu_geometry_2d_size_y_delta[ tileID ][ patchIdx ] | ue(v) |
| midu_3d_offset_u[ tileID ][ patchIdx ] | ue(v) |
| midu_3d_offset_v[ tileID ][ patchIdx ] | ue(v) |
| midu_3d_offset_d[ tileID ][ patchIdx ] | ue(v) |
| if( asps_normal_axis_max_delta_value_enabled_flag ) | |
| midu_3d_range_d[ tileID ][ patchIdx ] | ue(v) |
| } | |

| | De- |
|---|---|
| | scrip- |
| | tor |
| mesh_merge_data_unit( tileID, patchIdx ) { | |
| if( NumRefIdxActive > 1 ) | |
| mmdu_ref_index[ tileID ][ patchIdx ] | ue(v) |
| mmdu_ref_patch_index[ tileID ][ patchIdx ] | se(v) |
| mmdu_vertex_count_delta[ tileID ][ patchIdx ] | se(v) |
| mmdu_triangle_count_delta[ tileID ][ patchIdx ] | se(v) |
| mmdu_override_2d_params_flag[ tileID ][ patchIdx ] | u(1) |
| mmdu_override_3d_params_flag[ tileID ][ patchIdx ] | u(1) |
| if( mpdu_override_2d_params_flag[ tileID ][ patchIdx ] ) { | |
| mmdu_geometry_2d_pos_x[ tileID ][ patchIdx ] | ue(v) |
| mmdu_geometry_2d_pos_y[ tileID ][ patchIdx ] | ue(v) |
| mmdu_geometry_2d_size_x_minus1[ tileID ][ patchIdx ] | ue(v) |
| mmdu_geometry_2d_size_y_minus1[ tileID ][ patchIdx ] | ue(v) |
| } | |
| if(mpdu_override_3d_params_flag[ tileID ][ patchIdx ] ) { | |
| mmdu_3d_offset_u[ tileID ][ patchIdx ] | ue(v) |
| mmdu_3d_offset_v[ tileID ][ patchIdx ] | ue(v) |
| mmdu_3d_offset_d[ tileID ][ patchIdx ] | ue(v) |
| if( asps_normal_axis_max_delta_value_enabled_flag ) | |
| mmdu_3d_range_d[ tileID ][ patchIdx ] | ue(v) |
| } | |
| } | |

Descriptor

mesh_skip_data_unit( tileID, patchIdx ) {
}

| | De- |
|---|---|
| | scrip- |
| | tor |
| mesh_raw_data_unit( tileID, patchIdx ) { | |
| if( AuxTileHeight[ TileIDToIndex[ tileID ] ] > 0) | |
| mrdu_patch_in_auxiliary_video_flag[ tileID ][ | u(1) |
| patchIdx ] | |
| mrdu_patch_submesh_id[ tileID ][patchIdx ] | |
| mrdu_vertex_count_delta[ tileID ][ patchIdx ] | se(v) |
| mrdu_triangle_count_delta[ tileID ][ patchIdx ] | se(v) |
| mrdu_geometry_2d_pos_x[ tileID ][ patchIdx ] | ue(v) |
| mrdu_geometry_2d_pos_y[ tileID ][ patchIdx ] | ue(v) |
| mrdu_geometry_2d_size_x_minus1[ tileID ][ patchIdx ] | ue(v) |
| mrdu_geometry_2d_size_y_minus1[ tileID ][ patchIdx ] | ue(v) |
| mrdu_3d_offset_u[ tileID ][ patchIdx ] | ue(v) |
| mrdu_3d_offset_v[ tileID ][ patchIdx ] | ue(v) |
| mrdu_3d_offset_d[ tileID ][ patchIdx ] | ue(v) |
| for(i=0; i< asps_vmc_ext_num_attribute_video; i++){ | |
| if(afps_vmc_ext_direct_attribute_projection_enabled | |
| [ tileID ][ patchIdx ][ i ]){ | |
| mrdu_attributes_2d_pos_x[ tileID ][ patchIdx ][ i ] | ue(v) |
| mrdu_attributes_2d_pos_y[ tileID ][ patchIdx ][ i ] | ue(v) |
| mrdu_attributes_2d_size_x_minus1[ tileID ][ patchIdx ][ i ] | ue(v) |
| mrdu_attributes_2d_size_y_minus1[ tileID ][ patchIdx ][ i ] | ue(v) |
| mrdu_projection_id[ tileID ][ patchIdx ][ i ] | ue(v) |
| mrdu_orientation_index[ tileID ][ patchIdx ][ i ] | ue(v) |
| } | |
| } | |
| } | |

The signaling of the base mesh sub-bitstream is also under investigation and is tentatively proposed in [A. Tourapis, J. Kim, D. Podborski, K. Mammou, Base mesh data substream format for VDMC, WG 07 MPEG 3D Graphics Coding and Haptics Coding, input document m60362, July 2022, Online] as follows.

One of the features of the current V-DMC specification design is the support for a base mesh signal that can be encoded using any currently or future specified static mesh codec. For example, such information could be coded using Draco 3D Graphics Compression. Such representation could provide the basis for applying other decoded information to reconstruct the output mesh frame within the context of V-DMC.

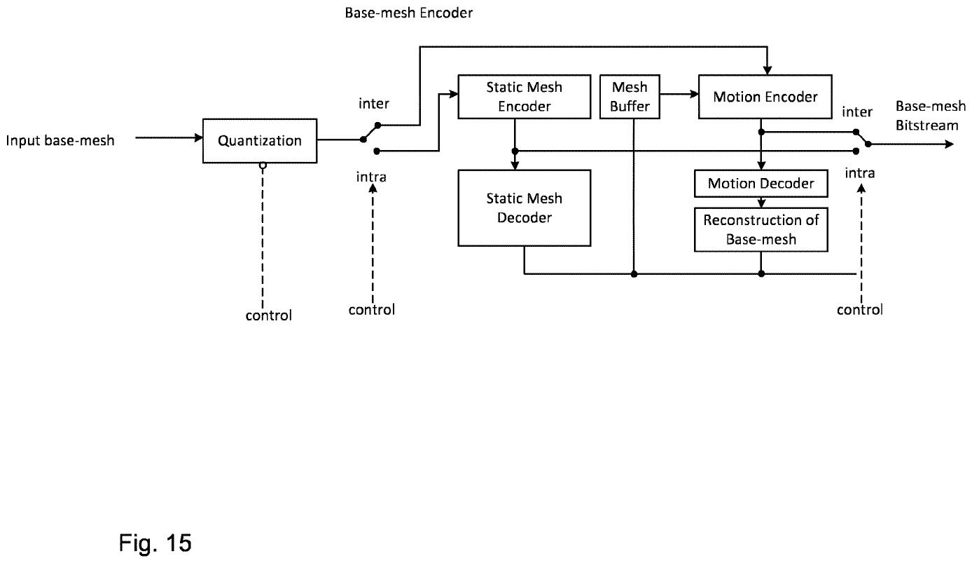

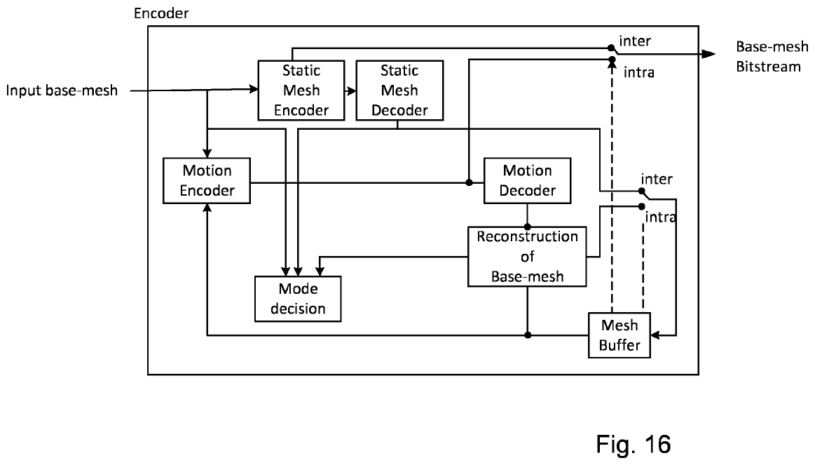

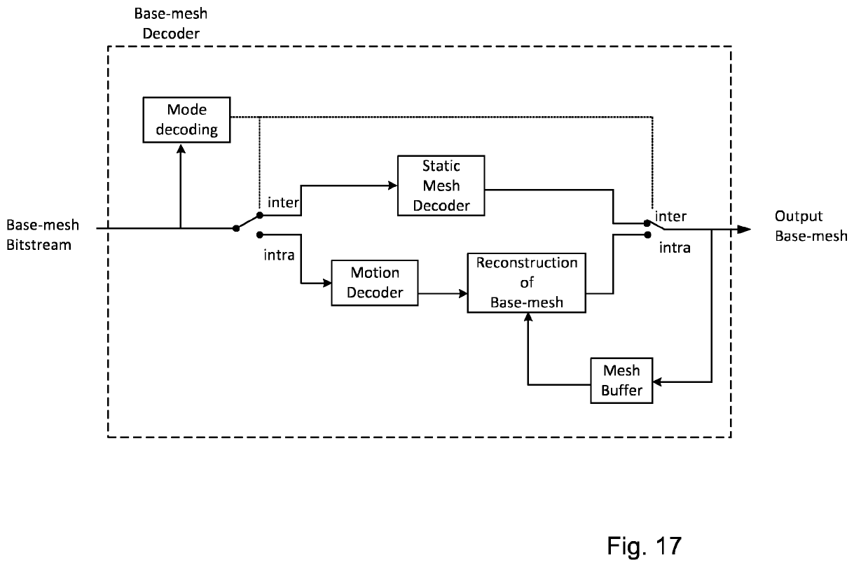

Furthermore, for coding dynamic mesh frames, it is highly desirable to be able to exploit any temporal correlation that may exist with previously coded base mesh frames. In the original design (see FIG. 15 illustrating an example of a base mesh encoder in a V-DMC decoder, 16 illustrating an example of a base mesh encoder, and 17 illustrating an example of a base mesh decoder) [K. Mammou, J. Kim, A. Tourapis, D. Podborski, K. Kolarov, “[V-CG] Apple's Dynamic Mesh Coding CfP Response,” ISO/IEC JTC1/SC29/WG7/m59281, Online, April 2022.], this was accomplished by encoding a mesh motion field instead of directly encoding the base mesh, and using this information and a previously encoded base mesh to reconstruct the base mesh of the current frame. Such approach could be seen as the equivalent of inter prediction in video coding.

It is possible to associate all coded base mesh frames or motion fields with information that could help determine their decoding output order as well as their referencing relationships. It is possible, for example, that better coding efficiency could be achieved if the coding order of all frames does not follow the display order or by using as reference for generating a motion field for frame N an arbitrary previously coded motion field or base mesh instead of the immediately previous coded one. Also highly desirable is the ability to instantly detect random access points and independently decode multiple sub-meshes that together can form a single mesh, much like subpictures in video compression.

For all the above reasons, a new Base Mesh Substream format is introduced. This new format is very similar to a video coding format such as HEVC or the atlas sub-bitstream used in V3C, with the base mesh sub-bitstream also constructed using NAL units. High Level Syntax (HLS) structures such as base mesh sequence parameter sets, base mesh frame parameter sets, submesh layer are also specified.

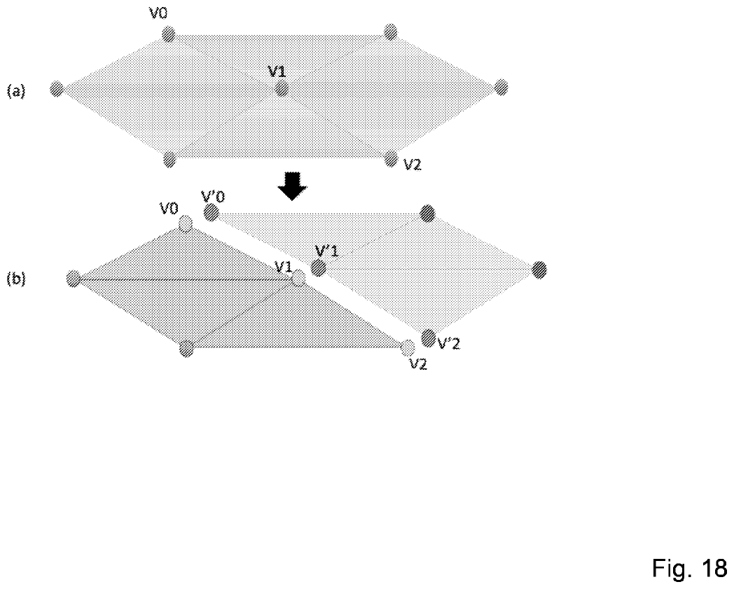

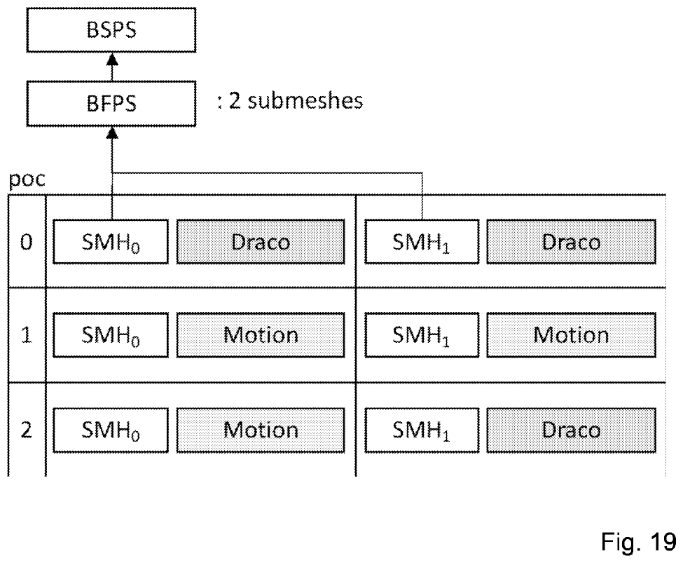

One of the desirable features of this design is the ability to segment a mesh into multiple smaller partitions, referred to in this document as submeshes. This has been illustrated by means of an example in FIG. 18. These submeshes can be decoded completely independently, which can help with partial decoding and spatial random access. Although it may not be a requirement for all applications, some applications may require that the segmentation in submeshes remains consistent and fixed in time. The submeshes do not need to use the same coding type, i.e., for one frame one submesh may use intra coding while for another inter coding could be used at the same decoding instance, but it is commonly a requirement that the same coding order is used and the same references are available for all submeshes corresponding at a particular time instance. Such restrictions can help guarantee proper random-access capabilities for the entire stream. An example where two submeshes are used is shown by an example in FIG. 19.

As discussed earlier, the new bitstream is also based on NAL units, and it is similar to those of the atlas sub-bitstream in V3C. The syntax is provided below.

### General NAL Unit Syntax:

| | |
|---|---|
| bmesh_nal_unit( NumBytesInNalUnit ) { | |
| bmesh_nal_unit_header( ) | |
| NumBytesInRbsp = 0 | |
| for( i = 2; i < NumBytesInNalUnit; i++ ) | |
| rbsp_byte[ NumBytesInRbsp++ ] | b(8) |
| } | |

### NAL Unit Header Syntax:

| | |
|---|---|
| bmesh_nal_unit_header( ) { | |
| bmesh_nal_forbidden_zero_bit | f(1) |
| bmesh_nal_unit_type | u(6) |
| bmesh_nal_layer_id | u(6) |
| bmesh_nal_temporal_id_plus1 | u(3) |
| } | |

The following section contains some of the semantics that correspond to the above syntax structures.

NumBytesInNalUnit in the general NAL unit semantics specifies the size of the NAL unit in bytes. This value is required for decoding of the NAL unit. Some form of demarcation of NAL unit boundaries is necessary to enable inference of NumBytesInNalUnit.

It is to be appreciated that the mesh coding layer (MCL) is specified to efficiently represent the content of the mesh data. The NAL is specified to format that data and provide header information in a manner appropriate for conveyance on a variety of communication channels or storage media. All data are contained in NAL units, each of which contains an integer number of bytes. A NAL unit specifies a generic format for use in both packet-oriented and bitstream systems. The format of NAL units for both packet-oriented transport and sample streams is identical except that in the sample stream format specified in Annex TBD each NAL unit can be preceded by an additional element that specifies the size of the NAL unit.

rbsp_byte[i] is the i-th byte of an RBSP. An RBSP is specified as an ordered sequence of bytes as follows:

The RBSP contains a string of data bits (SODB) as follows:
If the SODB is empty (i.e., zero bits in length), the RBSP is also empty.
Otherwise, the RBSP contains the SODB as follows:
   The first byte of the RBSP contains the first (most significant, left-most) eight bits of the SODB; the next byte of the RBSP contains the next eight bits of the SODB, etc., until fewer than eight bits of the SODB remain.
   The rbsp_trailing_bits( ) syntax structure is present after the SODB as follows:
      The first (most significant, left-most) bits of the final RBSP byte contain the remaining bits of the SODB (if any).
      The next bit consists of a single bit equal to 1 (i.e., rbsp_stop_one_bit).
      When the rbsp_stop_one_bit is not the last bit of a byte-aligned byte, one or more bits equal to 0 (i.e., instances of rbsp_alignment_zero_bit) are present to result in byte alignment.

One or more cabac_zero_word 16-bit syntax elements equal to 0x0000 may be present in some RBSPs after the rbsp_trailing_bits( ) at the end of the RBSP.

Syntax structures having these RBSP properties are denoted in the syntax tables using an “_rbsp” suffix. These structures are carried within NAL units as the content of the rbsp_byte[i] data bytes. As an example, the following may be considered as typical content:
atlas_sequence_parameter_set_rbsp( ), which is used to carry parameters related to atlas on a sequence level.
atlas_frame_parameter_set_rbsp( ), which is used to carry parameters related to atlas on a frame level and are valid for one or more atlas frames.
sei_rbsp( ), used to carry SEI (Supplemental Enhancement Information) messages in NAL units.
atlas_tile_group_layer_rbsp( ), used to carry patch layout information for tile groups.

When the boundaries of the RBSP are known, the decoder can extract the SODB from the RBSP by concatenating the bits of the bytes of the RBSP and discarding the rbsp_stop_one_bit, which is the last (least significant, right-most) bit equal to 1, and discarding any following (less significant, farther to the right) bits that follow it, which are equal to 0. The data necessary for the decoding process is contained in the SODB part of the RBSP.

Similar NAL unit types, as for the atlas case, have been defined for the base mesh enabling similar functionalities for random access and segmentation of the mesh. Unlike the atlas that is split into tiles, the concept of a sub-mesh and specific NAL units that correspond to coded mesh data have been defined. In addition, NAL units that can include metadata such as SEI messages have also been defined.

In particular, the base mesh NAL unit types supported are specified as follows:

| | | | NAL |
|---|---|---|---|
| | Name of | Content of base mesh NAL unit | unitype |
| bmesh_nal_unit_type | bmesh_nal_unit_type | and RBSP syntax structure | class |
| 0 | NAL_TRAIL_N | Coded sub-mesh of a non-TSA, | BMCL |
| 1 | NAL_TRAIL_R | non STSA trailing base mesh | |
| | | frame | |
| | | sub_mesh_layer_rbsp( ) | |
| 2 | NAL_TSA_N | Coded sub-mesh of a TSA base | BMCL |
| 3 | NAL_TSA_R | mesh frame | |
| | | sub_mesh_layer_rbsp( ) | |
| 4 | NAL_STSA_N | Coded sub-mesh of a STSA base | BMCL |
| 5 | NAL_STSA_R | mesh frame | |
| | | sub_mesh_layer_rbsp( ) | |
| 6 | NAL_RADL_N | Coded sub-mesh of a RADL base | BMCL |
| 7 | NAL_RADL_R | mesh frame | |
| | | sub_mesh_layer_rbsp( ) | |
| 8 | NAL_RASL_N | Coded sub-mesh of a RASL base | BMCL |
| 9 | NAL_RASL_R | mesh frame | |
| | | sub_mesh_layer_rbsp( ) | |
| 10 | NAL_SKIP_N | Coded sub-mesh of a skipped base | BMCL |
| 11 | NAL_SKIP_R | mesh frame | |
| | | sub_mesh_layer_rbsp( ) | |
| 12 | NAL_RSV_BMCL_N12 | Reserved non-IRAP sub-layer | BMCL |
| 14 | | non-reference BMCL mesh NAL | |
| | NAL_RSV_BMCL_N14 | unit types | |
| 13 | NAL_RSV_BMCL_R13 | Reserved non-IRAP sub-layer | BMCL |
| 15 | NAL_RSV_BMCL_R15 | reference BMCL mesh NAL unit | |
| | | types | |
| 16 | NAL_BLA_W_LP | Coded sub-mesh of a BLA base | BMCL |
| 17 | NAL_BLA_W_RADL | mesh frame | |
| 18 | NAL_BLA_N_LP | sub_mesh_layer_rbsp( ) | |
| 19 | NAL_IDR_W_RADL | Coded sub-mesh of an IDR base | BMCL |
| 20 | NAL_IDR_N_LP | mesh frame | |
| | | sub_mesh_layer_rbsp( ) | |
| 21 | NAL_CRA | Coded sub-mesh of a CRA base | BMCL |
| | | mesh frame | |
| | | sub_mesh_layer_rbsp( ) | |
| 22 | NAL_RSV_IRAP_BMCL_22 | Reserved IRAP BMCL NAL unit | BMCL |
| 23 | NAL_RSV_IRAP_BMCL_23 | types | |
| 24 . . . 29 | NAL_RSV_BMCL_24 . . . | Reserved non-IRAP BMCL NAL | BMCL |
| | NAL_RSV_BMCL_29 | unit types | |
| 30 | NAL_BMSPS | Base mesh sequence parameter set | non- |
| | | bmesh_sequence_parameter_set_rbsp( ) | BMCL |
| 31 | NAL_BMFPS | Base mesh frame parameter set | non- |
| | | bmesh_frame_parameter_set_rbsp( ) | BMCL |
| 32 | NAL_AUD | Access unit delimiter | non- |
| | | access_unit_delimiter_rbsp( ) | BMCL |
| 33 | NAL_EOS | End of sequence | non- |
| | | end_of_sequence_rbsp( ) | BMCL |
| 34 | NAL_EOB | End of bitstream | non- |
| | | end_of_bmesh_sub_bitstream_rbsp( ) | BMCL |
| 35 | NAL_FD | Filler | non- |
| | | filler_data_rbsp( ) | BMCL |
| 36 | NAL_PREFIX_NSEI | Non-essential supplemental | non- |
| 37 | NAL_SUFFIX_NSEI | enhancement information | BMCL |
| | | sei_rbsp( ) | |
| 38 | NAL_PREFIX_ESEI | Essential supplemental | non- |
| 39 | NAL_SUFFIX_ESEI | enhancement information | BMCL |
| | | sei_rbsp( ) | |
| 40 . . . 44 | NAL_RSV_NBMCL_40 | Reserved non-BMCL NAL unit | non- |
| | NAL_RSV_NBMCL_44 | types | BMCL |
| 45 . . . 63 | NAL_UNSPEC_45 | Unspecified non-BMCL NAL unit | non- |
| | NAL_UNSPEC_63 | types | BMCL |

In the following a base mesh sequence parameter set RBSP syntax is discussed. As with similar bitstreams, the primary syntax structure that is defined for a base mesh bitstream is a sequence parameter set. This syntax structure contains basic information about the bitstream, identifying features for the codecs supported for either the intra coded and inter coded meshes, as well as information about references

### General Base Mesh Sequence Parameter Set RBSP Syntax:

| | Descriptor |
|---|---|
| bmesh_sequence_parameter_set_rbsp( ) { | |
| bmsps_sequence_parameter_set_id | u(4) |
| bmesh_profile_tier_level( ) | |
| bmsps_intra_mesh_codec_id | u(8) |
| bmsps_inter_mesh_codec_id | u(8) |
| bmsps_geometry_3d_bit_depth_minus1 | u(5) |
| bmsps_facegroup_segmentation_method | ue(v) |
| bmsps_mesh_attribute_count | u(7) |
| for( i = 0; i < bmsps_mesh_attribute_count; i++ ) { | |
| bmsps_mesh_attribute_type_id[ i ] | u(4) |
| bmsps_attribute_bit_depth_minus1[ i ] | u(5) |
| bmsps_attribute_msb_align_flag[ i ] | u(1) |
| } | |
| bmsps_log2_max_mesh_frame_order_cnt_lsb_minus4 | ue(v) |
| bmsps_max_dec_mesh_frame_buffering_minus1 | ue(v) |
| bmsps_long_term_ref_mesh_frames_flag | u(1) |
| bmsps_num_ref_mesh_frame_lists_in_bmsps | ue(v) |
| for( i = 0; i < | |
| bmsps_num_ref_mesh_frame_lists_in_bmsps; i++ ) | |
| bmesh_ref_list_struct( i ) | |
| bmsps_extension_present_flag | u(1) |
| if( bmsps_extension_present_flag ) { | |
| bmsps_extension_count_minus1 | u(7) |
| } | |
| if( bmsps_extension_present_flag ){ | |
| bmsps_extensions_length_minus1 | ue(v) |
| while( more_rbsp_data( ) ) | |
| bmsps_extension_data_flag | u(1) |
| } | |
| rbsp_trailing_bits( ) | |
| } | |

bmsps_intra_mesh_codec_id indicates the static mesh codec used to encode the base meshes in this base mesh sub-bitstream. It could be associated with a specific mesh or motion mesh codec through the profiles specified in the corresponding specification or could be explicitly indicated with an SEI message as is done in the V3C specification for the video sub-bitstreams.
bmsps_intra_mesh_data_size_precision_bytes_minus1 (+1) specifies the precision, in bytes, of the size of the coded mesh data.
bmsps_inter_mesh_codec_present_flag indicates if a specific codec indicated by bmsps_inter_mesh_codec_id is used to encode the inter predicted submeshes
bmsps_inter_mesh_data_size_precision_bytes_minus1(+1) specifies the precision, in bytes, of the size of the inter predicted mesh data. This precision is signaled considering the size of the coded mesh data and the inter predicted mesh data (e.g., motion field) can be significantly different.
bmsps_facegroup_segmentation_method indicates how facegroups could be derived for a mesh. A facegroup is a set of triangle faces in a submesh. Each triangle face is associated with a FacegroupId indicating the facegroup it belongs to. When bmsps_facegroup_segmentation_method is 0, then FacegroupId is present directly in the coded submesh. Other values indicate that the facegroup can be derived using different methodologies based on the characteristics of the stream. For example, value 1 means that there is no FacegroupId associated with any face. A value 2 means that all faces are identified with a single identification, a 3 that facegroups are identified based on the connected component method, while a value of 4 indicates that each individual face has its own unique identification. Currently ue(v) is used to indicate bmsps_facegroup_segmentation_method, but fixed length coding or partitioning to more elements could have been used instead.

### Base Mesh Profile, Tier, and Level Syntax

| | Descriptor |
|---|---|
| bmesh_profile_tier_level( ) { | |
| bmptl_tier_flag | u(1) |
| bmptl_profile_codec_group_idc | u(7) |
| bmptl_profile_toolset_idc | u(8) |
| bmptl_reserved_zero_32bits | u(32) |
| bmptl_level_idc | u(8) |
| bmptl_num_sub_profiles | u(6) |
| bmptl_extended_sub_profile_flag | u(1) |
| for( i = 0; I < ptl_num_sub_profiles; i++ ) { | |
| bmptl_sub_profile_idc[ i ] | u(v) |
| } | |
| bmptl_toolset_constraints_present_flag | u(1) |
| if( bmptl_toolset_constraints_present_flag ) { | |
| bmesh_profile_toolset_constraints_information( ) | |
| } | |
| } | |

bmptl_extended_sub_profile_flag providing support for sub profiles can be quite useful for further restricting the base mesh profiles depending on usage and applications.

The base mesh frame parameter set has the frame level information such as number of submeshes in the frames corresponding to one mfh_mesh_frm_order_cnt_lsb. A submesh is coded in one mesh_data_submesh_layer( ) and is independently decodable from other submeshes. In the case of inter frame prediction, a submesh can refer only to the submeshes with the same smh_id in its associated reference frames.

| | Descriptor |
|---|---|
| bmesh_frame_parameter_set_rbsp( ) { | |
| bfps_mesh_sequence_parameter_set_id | u(4) |
| bfps_mesh_frame_parameter_set_id | u(4) |
| bmesh_sub_mesh_information( ) | |
| bfps_output_flag_present_flag | u(1) |
| bfps_num_ref_idx_default_active_minus1 | ue(v) |
| bfps_additional_lt_afoc_lsb_len | ue(v) |
| bfps_extension_present_flag | u(1) |
| if( bfps_extension_present_flag ) | |
| bfps_extension_8bits | u(8) |
| if( bfps_extension_8bits ) | |
| while( more_rbsp_data( ) ) | |
| bfps_extension_data_flag | u(1) |
| rbsp_trailing_bits( ) | |
| } | |

| | Descriptor |
|---|---|
| bmesh_sub_mesh_information( ) { | |
| bsmi_use_single_mesh_flag | u(1) |
| if(!bsmi_use_single_mesh_flag){ | |
| bsmi_num_submeshes_minus1 | u(8) |
| } | |
| else | |
| bsmi_num_submeshes_minus1 = 0 | |
| bsmi_signalled_submesh_id_flag | u(1) |
| if( bsmi_signalled_submesh_id_flag ) { | |
| bmsi_signalled_submesh_id_length_minus1 | ue(v) |
| for( i = 0; i < bmsi_signalled_submesh_id_length_minus1 + 1; i++ | |
| ) | |
| bmsi_submesh_id[ i ] | u(v) |
| SubMeshIDToIndex[ bmsi_submesh_id[ i ] ] = i | |
| SubMeshIndexToID[ i ] = bmsi_submesh_id[ i ] | |

```
      }
    }
```

```
    else
        for( i = 0; i < bsmi_num_submeshes_minus1 + 1; i++ ) {
            bmsi_submesh_id[ i ] = i
            SubMeshIDToIndex[ i ] = i
            SubMeshIndexToID[ i ] = i
          }
}
```

A bmesh_submesh_layer contains a submesh information. One or more bmesh_submesh_layer_rbsp can correspond to one mesh frame indicated by mfh_mesh_frm_order_cnt_lsb.

```
bmesh_submesh_layer_rbsp( ) {
  submesh_header( )
  submesh_data_unit( mfh_submesh_type, SubMeshUnitSize )
  rbsp_trailing_bits( )
}
```

### Submesh Header Syntax:

| | Descriptor |
|---|---|
| submesh_header( ) { | |
| if( nal_unit_type >= NAL_BLA_W_LP && nal_unit_type <= NAL | |
| _RSV_IRAP_ACL_29 ) | |
| smh_no_output_of_prior_submesh_frames_flag | u(1) |
| smh_submesh_frame_parameter_set_id | u(4) |
| smh_id | u(v) |
| subMeshID = smh_id | |
| smh_type | ue(v) |
| if( bfps_output_flag_present_flag ) | |
| smh_mesh_output_flag | u(1) |
| smh_basemesh_frm_order_cnt_lsb | u(v) |
| if( bmsps_num_ref_mesh_frame_lists_in_bmsps > 0 ) | |
| smh_ref_basemesh_frame_list_msps_flag | u(1) |
| if( smh_ref_basemesh_frame_list_msps_flag == 0 ) | |
| ref_list_struct( bmsps_num_ref_mesh_frame_lists_in_bmsps ) | |
| else if( bmsps_num_ref_mesh_frame_lists_in_bmsps > 1 ) | |
| smh_ref_mesh_frame_list_idx | u(v) |
| for( j = 0; j < NumLtrMeshFrmEntries[ RlsIdx ]; j++ ) { | |
| msh_additional_mfoc_lsb_present_flag[ j ] | u(1) |
| if( msh_additional_afoc_lsb_present_flag[ j ] ) | |
| msh_additional_mfoc_lsb_val[ j ] | u(v) |
| } | |
| if( smh_type != SKIP_SUBMESH ) { | |
| if( smh_type == P_SUBMESH | |
| && num_ref_entries[ RlsIdx ] > 1 ) { | |
| msh_num_ref_idx_active_override_flag | u(1) |
| if( msh_num_ref_idx_active_override_flag ) | |
| msh_num_ref_idx_active_minus1 | ue(v) |
| } | |
| } | |
| byte_alignment( ) | |
| } | |

smh_id is the id of the current submesh contained in the mesh data submesh data.
smh_type indicates how the mesh is coded. If smh_type is I_SUBMESH, the mesh data is coded with the indicated static mesh codec. If smh_type is P_SUBMESH, inter prediction is used to code the mesh data.

| | mfh_submesh_type | name of mfh_submesh_type |
|---|---|---|
| 1 | 0 | I_SUBMESH |
| 2 | 1 | P_SUBMESH |
| 3 | 2 | SKIP_SUBMESH |

### Submesh Data Unit:

Descriptor

```
submesh_data_unit( subMeshID , unitSize) {
  if( smh_type == I_SUBMESH ) {
    smdu_intra_sub_mesh_unit(unitSize)
  }
  else if( smh_type == P_SUBMESH ) {
    smdu_inter_sub_mesh_unit(unitSize)
  }
  else if( smh_type == SKIP_SUBMESH ) {
    // TBD_skip_sub_mesh_data_unit( )
  }
}
```

smdu_intra_sub_mesh_unit(unitSize) contains a sub mesh unit stream of size unitSize, in bytes, as an ordered stream of bytes or bits within which the locations of unit boundaries are identifiable from patterns in the data. The format of such sub mesh unit stream is identified by a 4CC code as defined by bmptl_profile_codec_group_idc or by a component codec mapping SEI message.

smdu_inter_sub_mesh_unit(unitSize) contains a sub mesh unit stream of size unitSize, in bytes, as an ordered stream of bytes or bits within which the locations of unit boundaries are identifiable from patterns in the data. The format of such sub mesh unit stream is identified by a 4CC code as defined by bmptl_profile_codec_group_idc or by a component codec mapping SEI message.

The current basis for the V-DMC test model iteratively subdivides the base mesh and calculates displacement vectors for every generated vertex at each iteration. These displacement vectors can be filtered by a wavelet transform to improve their compression. The displacement vectors are necessary to reconstruct a deformed mesh that provides higher fidelity than the reconstructed base mesh. Following a spatial scalability philosophy, several scales, or levels of details (LODs) are defined based on iterative “midpoint” subdivision, and displacements are computed for each vertex of the mesh at each iteration. A level of detail refers to connectivity information, i.e., which vertex and triangles belong to a corresponding LOD. LODs are represented as hierarchical manner, so that the lowest level of LOD (i.e., LOD_0) represents the lowest quality, with smallest data chunk, and then the following levels, i.e., LOD_1, LOD_2 etc. increasingly add details to the lowest quality to reconstruct a higher quality mesh. When all LODs are reconstructed, the full mesh resolution is available. As an example, if LOD_0 contains N faces, LOD_1 contains 4*N faces, LOD_2 4*4*N faces, and LOD_3 4*4*4*N faces of additional information. “Midpoint” subdivision-based interpolation combined with the “linear” wavelet filter leads to relatively small and sparse displacement vectors at the third LOD, and depending on the mesh content, also at the second LOD. However, for the first LOD, for the chosen base mesh resolutions and target rates, it can be observed that the midpoint subdivision leads to large residuals that are difficult to compress with video coding. This can be explained by the fact that the deformed mesh is much smoother at higher levels of details than the base mesh itself, while at the first LOD, displacement vectors are large and they are not necessarily well predicted by the midpoint subdivision combined with the “linear” wavelet filter.

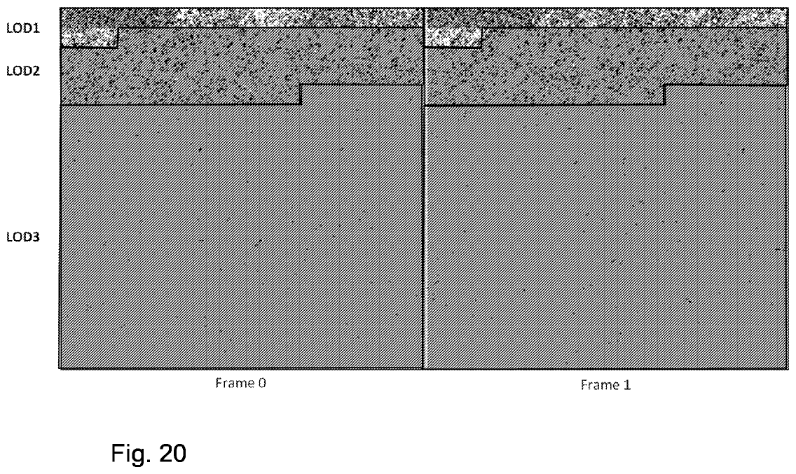

Furthermore, to exploit the temporal redundancy in the mesh sequence, the V-DMC approach relies on the video coding of the displacement video component and a motion compression approach to encode base mesh motion data. While motion compression for base meshes is optimized for the particular nature of meshes, the video coding of displacements is not optimal for such signal. Indeed, video codecs group pixels in hierarchies of blocks (AVC) or coding tree units (HEVC, VVC) that group together pixels that correspond to displacements of vertices that are not neighbors. Hence there is little redundancy spatially; the signal looks like salt and pepper noise as in FIG. 20, and motion estimation is complex as distortion is averaged on blocks or sub-blocks that do not represent regions of neighboring points or displacement vectors on the mesh surface signal. Hence, temporal redundancy as well as spatial redundancy reduction is very limited when using video codecs on the displacement video component. FIG. 20 illustrates an example of displacement video components (after linear wavelet prediction) for two consecutive frames. There is not spatial redundancy in blocks that can be efficiently exploited by video codecs. There is pixel-to-pixel spatial redundancy between consecutive frames, however, block-based approaches will estimate distortion based on blocks, and likely generate sub-optimal residuals that will cause ringing effects after transform coefficient quantization inside the video codec.

The present embodiments relate to exploiting point-to-point temporal redundancy of the displacement vectors with a temporal lifting (or wavelet) scheme combined with the spatial lifting (or wavelet) scheme (i.e., 3D+T lifting scheme) to efficiently reduce redundancy at both spatial and temporal levels of details. These embodiments enable creating spatial LODs (Level-Of-Detail) as well as temporal LODs that enable progressive and scalable decoding of the compressed mesh sequence. The spatial LODs are based on the mesh connectivity (vertex indices and triangles), and the temporal LODs are based on the mesh frame index (i.e., the temporal index). The temporal LOD_0 corresponds to a lower frame rate of the input mesh sequence and adding subsequent LODs increases the frame rate hierarchically. The present embodiments relate to combining spatial and temporal LODs (3D+T lifting scheme, or 3D+T transform) into a single framework. In the current description, phrase “3D+T wavelet transform” refers to spatio-temporal wavelet transform, where-instead of term “transform”-term “decomposition” may also be used.

With respect to present embodiments, terms “low frequency wavelet coefficient” and “high frequency wavelet coefficient” describe the output of the 3D+T lifting scheme. The 3D+T lifting scheme consists of a hierarchy of temporal and spatial lifting schemes. Data can therefore be processed once through spatial lifting transform and the output if this process is then the input of a temporal lifting transform. Alternatively, the temporal lifting transform may be processed first and then the spatial lifting transform is applied afterwards. Therefore, the low and high frequency wavelet coefficients are output of a first lifting scheme filtering step, whereupon it follows that those low and high frequency wavelet coefficients are input of another lifting scheme filtering step.

In this disclosure “spatial low frequency wavelet coefficients” refers to the output of a spatial lifting scheme (at LOD spatial_LOD_0) and “spatial high frequency wavelet coefficients” refers to the output of a spatial lifting scheme (at LOD temporal_LOD_i with i>0). Temporal low/high frequency wavelet coefficients refer to the output of a temporal lifting scheme.

When the temporal lifting scheme follows the spatial lifting scheme, the spatial low/high wavelet coefficients are the input of the temporal lifting scheme and the output will be temporal low/high frequency input wavelet coefficients, where input is either “spatial low frequency” or “spatial high frequency”, and vice versa.

Some of present embodiments also relate to signalling of 3D+T wavelet transform type (i.e., temporal lifting scheme or spatial lifting scheme), where the temporal lifting scheme is signaled at sequence or frame parameter level.

Further, some of the present embodiments relate to decoding process that determines the transform type at sequence or frame parameter set.

Further, some of the present embodiments relate to encoding process that finds the best temporal wavelet transform type per frame or sequence.

These and other embodiments provide advantages. For example, the embodiments enable a better reduction of redundancy in the temporal domain due to a hierarchical decomposition. Because the wavelet coefficients are not packed in frames so that blocks can efficiently be motion-compensated, video encoders fall back to SKIP mode and achieve inferior compression performance.

The present embodiments are applied in a V-DMC framework and follows the procedure as described above: the input data is a textured mesh sequence comprising frames, where each input frame is simplified to generate a base mesh. To enable the decoder to perform the same operations as the encoder, the base mesh is encoded, decoded, and reconstructed in the encoder, to generate a reconstructed base mesh.

Once the reconstructed base mesh is generated, a subdivision process is applied and each edge of the reconstructed base mesh is iteratively subdivided in two, generating new vertices and new triangles. Each subdivision iteration generates a LOD. Displacement vectors are defined and applied to the subdivided mesh.

At this point, the 3D+T lifting scheme is applied. As mentioned, the 3D+T lifting scheme comprises temporal wavelet lifting scheme and spatial wavelet lifting scheme. It is appreciated that the order of applying the temporal and spatial wavelet lifting scheme may vary.

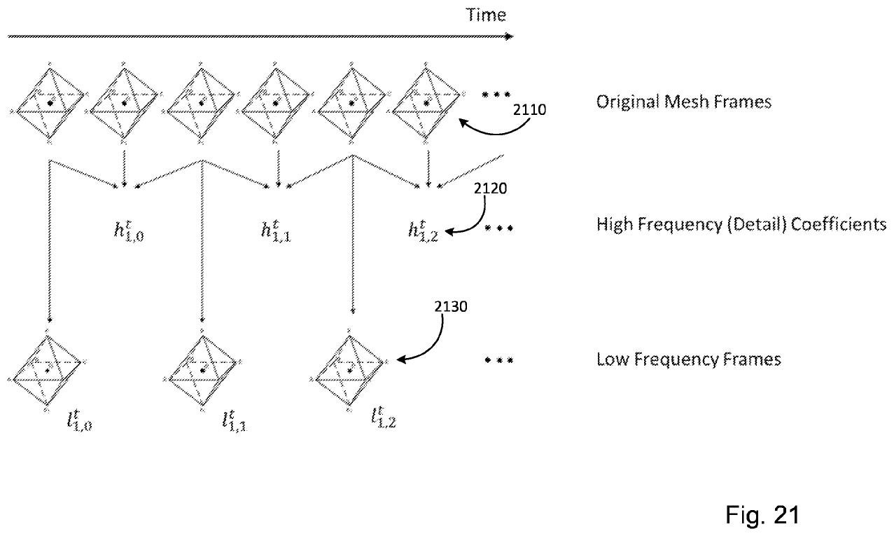

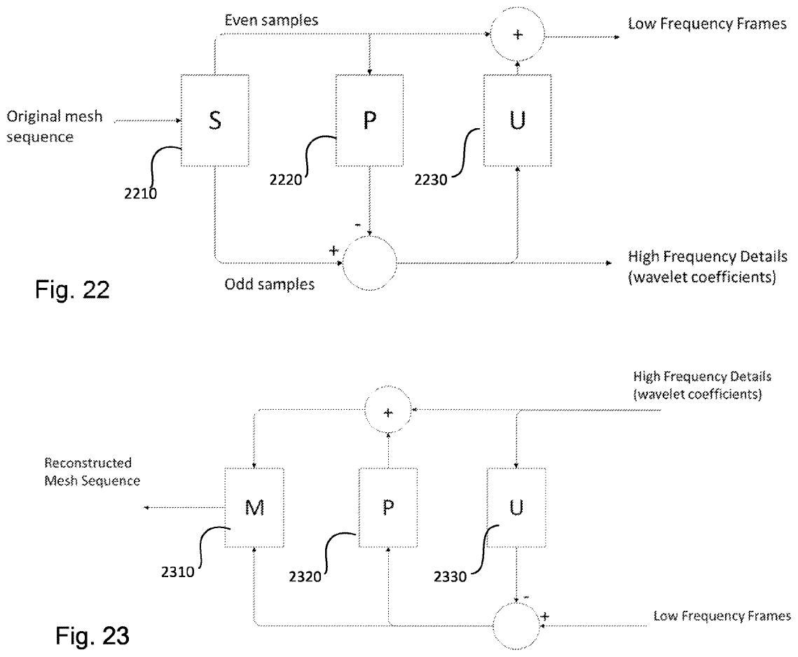

An example of temporal wavelet lifting scheme (i.e., temporal wavelet decomposition or transform method) is illustrated in FIG. 21. In this example, for one decomposition level (or temporal LOD), the original mesh frames 2110 (also referred to as “original mesh sequence”) are separated into two subsequences 2120, 2130, for example, using odd frame indices and even frame indices. For example, the even subsequence may be selected as low frequency subsequence 2130, while the odd subsequence may be selected as high frequency subsequence to generate wavelet coefficients 2120. The wavelet coefficients 2120 may be generated using a prediction 2220 and update 2230 steps as depicted on FIG. 22, after the original mesh sequence has been separated 2210 into even and odd samples. Prediction 2220 can be implemented as vertex-to-corresponding-vertex from direct mesh frame temporal neighbours, in other words “a per-vertex mesh motion compensation” from e.g., two reference frames. One can set more than two temporal neighbours or use different weights for this prediction filter. The update filter 2230 may consist of a weighted average of the corresponding vertices across neighboring mesh frames and may be used in lifting scheme to re-introduce some part of the original signal in the residual after prediction so as to regularize and improve coding for successive decomposition levels (if enabled).

In particular, in FIG. 22, for filtering LOD_1 based on LOD_0, the input samples are the base mesh frames and subdivided mesh frames at LOD_1.

The splitter module 2210 multiplexes LOD_0 and LOD_1 such that the odd samples are the subdivided mesh frames after one iteration: LOD_1, and the even samples are the reconstructed mesh frames: LOD_0. The prediction module 2220 takes the even samples (LOD_0) to predict the odd samples (LOD_1). The result of the prediction module is subtracted to the odd samples (LOD_1) and the difference is called (high frequency) details or (high frequency) wavelet coefficient or displacement coefficient interchangeably. The update module 2230 takes the wavelet coefficients as input and adds them (with a multiplication factor set to ⅛) to the even samples LOD_0. This is used to regularize the data that will be later quantized and compressed.

For filtering LOD_2 based on LOD_1, the input samples are the subdivided mesh frames at LOD_1 and the subdivided mesh frames at LOD_2. The splitter module 2210 demultiplexes LOD_1 and LOD_2 such that the odd samples are the subdivided mesh frames after two iterations: LOD_2, and the even samples are the subdivided mesh frames after one iteration: LOD_1. The prediction module 2220 takes the even samples (LOD_1) to predict the odd samples (LOD_2). The result of the prediction module 2220 is subtracted to the odd samples (LOD_2) and this difference is called details or (high-frequency) wavelet coefficients interchangeably. The update module 2230 takes the wavelet coefficients as input and adds them (with a multiplication factor set to ⅛) to the even samples LOD_1. This is used to regularize the data that will be later quantized and compressed.

LOD_0 is considered as low frequency, LOD_i (with i>0) are considered high-frequency. LOD_i is often considered as “lower frequency” than LOD_i+1.

As said, and shown in FIG. 22, the original mesh sequence is decomposed (i.e., separated) 2210 in a low frequency subsequence (or sub-band) and a high frequency subsequence (or sub-band). The low frequency subsequence may consist of a temporal subsampling of the original sequence by a factor 2. The high frequency subsequence can be referred to as “details” or “wavelet coefficients” and it is generated by the forward lifting scheme: prediction and optionally update.

The high frequency subsequence representing such details (i.e., wavelet coefficients) is quantized and encoded (e.g., by entropy or arithmetic coding or video coding if coefficients are packets in a video frame). The low frequency sequence is encoded as a mesh frame sequence.

At a decoder shown in FIG. 23, the reconstruction of the mesh frame sequence consists of decoding the low frequency mesh frames and regenerating the high frequency corresponding mesh frames by applying a symmetric (also called as “backwards” or “inverse”) lifting scheme, i.e., first update 2230 if enabled, then prediction 2320.

In the backwards lifting scheme shown in FIG. 23, reconstructed sub-bands are multiplexed 2310 together in the original sequence order. The multiplexing step 2310 recomposes the reconstructed mesh sequence (or sub-band) from the reconstructed low frequency and high frequency subsequences (sub-bands).

In general, the reconstruction of LOD_i+1 based on LOD_i (where i is between 0 and 2) is as follows:
the update module 2330 takes the LOD_i+1 (high frequency details or wavelet coefficients) and its output is subtracted to the LOD i samples (lower frequency details or wavelet coefficients) to generate the reconstructed LOD i.
The LOD_i is then used by the prediction module 2320 to reconstruct the LOD_i+1 by adding the prediction to the LOD_i+1 details.
The muxer module 2310 multiplexes together the processed output LOD_i+1 and LOD_i that corresponds to the reconstructed LOD_i+1 and the LOD_i filtered details.

The reconstruction process ends when LOD_0 is reconstructed from LOD_1. In the present embodiments the spatio-temporal wavelet transform utilizes the process of FIGS. 22 and 23. However, according to an embodiment, spatial wavelet coefficients are used to generate temporal wavelet coefficients as shown in a following simplified example of a first spatial lifting scheme with two spatial LODs followed by two temporal LODs:
Base meshes are generated for each frame index and one subdivision iteration is applied to the base meshes with a set of displacement vectors for each newly created vertex. Then the lifting scheme on FIG. 22 is used to generate low-frequency spatial wavelet coefficients (the base meshes) and the high-frequency spatial wavelet coefficients (corresponding to the filtered displacement vectors);
The spatial low-frequency wavelet coefficients that are associated to a temporal frame index that belongs to the temporal LOD_0 are used as “even” samples and spatial low-frequency wavelet coefficients that are associated to a temporal frame index that belongs to the temporal LOD_1 are used as “odd” samples for FIG. 22 to generate temporal low-frequency wavelet coefficients corresponding to temporal LOD_0 (temporal LOD_0 & spatial LOD_0) and temporal high-frequency wavelet coefficients corresponding to temporal LOD_1 (temporal LOD_1 & spatial LOD_0), respectively;
The spatial high-frequency wavelet coefficients that are associated to a temporal frame index that belongs to the temporal LOD_0 are used as even samples and spatial low-frequency wavelet coefficients that are associated to a temporal frame index that belongs to the temporal LOD_1 are used as “odd” samples for FIG. 22 to generate temporal low-frequency wavelet coefficients corresponding to temporal LOD_0 (temporal LOD_0 & spatial LOD_1) and temporal high-frequency wavelet coefficients corresponding to temporal LOD_1 (temporal LOD_1 & spatial LOD_1), respectively;
The data streams corresponding to each combination of temporal and spatial LODs are compressed into bitstreams.

The temporal wavelet lifting scheme can be combined with the spatial (geometric) 3D wavelet lifting scheme in several different ways. Both lifting schemes can also include several levels (LODs), and these can be referred to as temporal LODs and spatial LODs.

A following notation is given as an example, although any other can be used, where t refers to temporal lifting scheme and s refers to spatial lifting scheme:

$${h}_{level , id}^{t} : {id}^{th} high frequency component of the {level}^{th} temporal LOD$$

$${l}_{level , id}^{t} : {id}^{th} low frequency component of the {level}^{th} temporal LOD$$

$${h}_{level , id}^{s} : {id}^{th} high frequency component of the {level}^{th} spatial LOD$$

$${l}_{level , id}^{s} : {id}^{th} low frequency component of the {level}^{th} spatial LOD$$

Combining different lifting schemes will be noted in the following from right to left (first lifting scheme to be applied is on the right, and then second lifting scheme to be applied is on the left, etc.):

$${l}_{{s}_{level}}^{s} {h}_{{t}_{level} , id}^{t} : {id}^{th} coefficient low frequency at temporal {t}_{level} LOD and spatial {s}_{level} LOD$$

In this case, the temporal lifting scheme at s_level LOD is applied after the temporal lifting scheme at t_level LOD. There can be an arbitrary number of spatial and temporal lifting schemes combined in multiple ways, with for example one temporal LOD and three spatial LODs and in different orders.

Since wavelet coefficients (i.e., displacements, details) are defined on mesh vertex positions, it is possible to apply the temporal or spatial lifting scheme to the wavelet coefficients. Instead of applying the lifting scheme to the geometry of the vertices, the lifting scheme is applied to the signal defined on the mesh vertices and predicted from spatial or temporal neighbors based on the chosen lifting scheme type.

An additional lifting scheme (temporal or spatial) can be applied to only a sub-band of the previous lifting scheme or to all of them. This is ultimately a choice of an encoder and can be motivated by several factors such as the compression performance, the presence of hardware acceleration for the coding or decoding of each type of sub-bands, low latency requirements for some reconstructed sub-bands, etc.

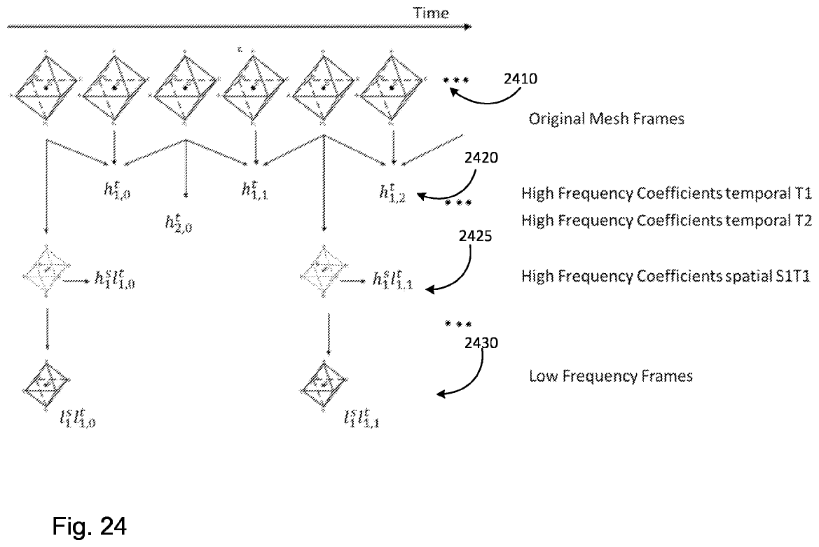

FIG. 24 illustrates an example, where first a temporal wavelet lifting scheme is applied to the original mesh frames 2410 to result in high frequency temporal coefficients 2420. Then a spatial wavelet lifting scheme is applied only to the temporal low frequency sub-band to produce high frequency spatial coefficients 2425. The advantage of this approach is to first reduce motion redundancy in the temporal sequence and then apply a geometric (spatial) subdivision lifting scheme to the temporal low frequency that consists of a mesh sequence at lower frame rate. Adding such spatial lifting scheme, improves the coding of the temporal low frequency sub-band significantly.

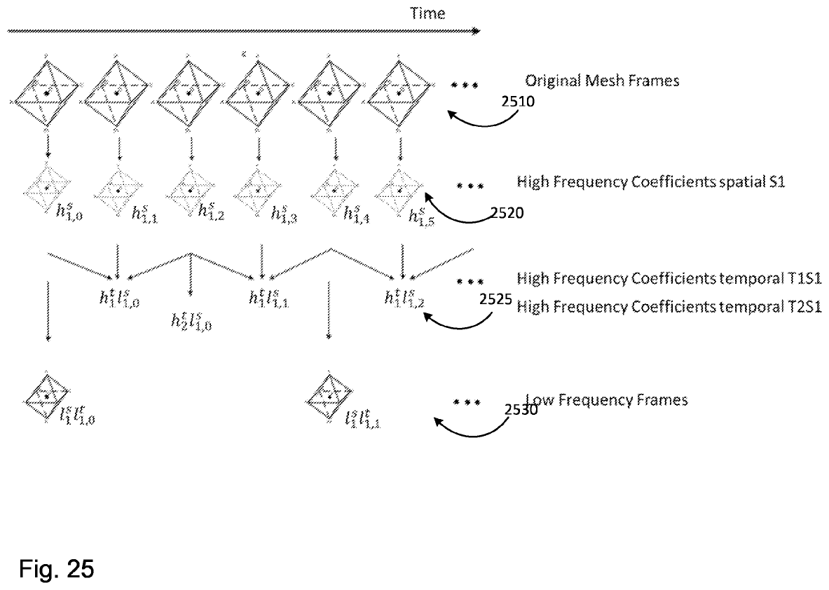

FIG. 25 illustrates another example, where first a spatial lifting scheme is applied to the original mesh frames 2510 to result in high frequency spatial coefficients 2520. Then the temporal lifting scheme is applied to high frequency spatial coefficients to produce high frequency temporal coefficients 2525 as illustrated in FIG. 25.

Other examples are possible, such as applying first a three-level spatial lifting scheme and then applying a one-level temporal lifting scheme to:
base meshes (low frequency spatial sub-band);
spatial LOD1 displacements;
spatial LOD2 displacements and LOD3 displacements.

An example sub-band encoding for this lifting scheme may then be as follows:
base mesh encoding of the low frequency temporal sub-band (only one out of tow base mesh is encoded using a static mesh codec or a motion codec)
entropy coding of the temporal details of the base meshes (high frequency of the temporal decomposition of the spatial low frequency sub-band)
frame packing in a displacement video component of the low frequency temporal sub-band of the LOD1 displacements at even frames, of the high frequency temporal sub-band of the LOD1 displacements at odd frames and of the LOD2 and LOD3 displacements for each frame.

Frame packing can use sub-pictures to separate sub-bands into independently decodable frame portions.

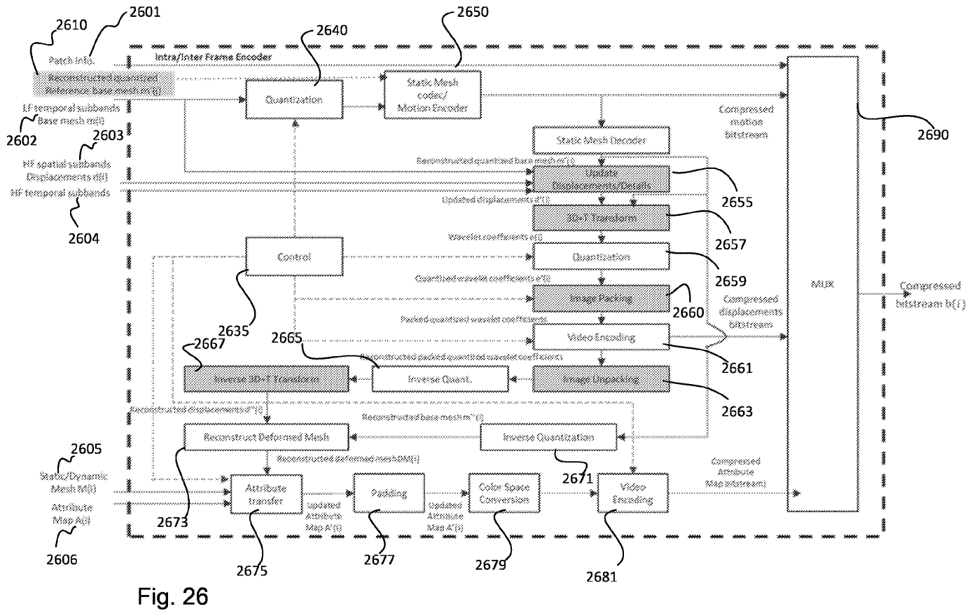

The encoding process according to an embodiment may comprise generating encoded sub-sequences for each sub-band of the combined lifting schemes, using entropy, arithmetic coding, or video coding after frame packing. Modules of the test model encoder modified by these changes is illustrated in FIG. 26.

The encoder receives reconstructed quantized reference base mesh 2610 as an input of the encoding process. Other inputs to the intra/inter frame encoder are low frequency (LF) temporal sub-bands base mesh m(i) 2602, the patch information 2601, high frequency (HF) spatial sub-bands displacements d(i) 2603 and HF temporal sub-bands 2604, the static/dynamic mesh M(i) 2605 and the attribute map A (i) 2606.

The low frequency (LF) temporal sub-bands base mesh m(i) 2602 being input to the encoder is first quantized Quantization module 2640, which can be dynamically tuned by a Control Module 2635. A module called Static Mesh Codec/Motion Encoder 2650 takes as input the LF temporal sub-bands base mesh 2602 and the reconstructed quantized reference base mesh 2610 to produce compressed motion information encoded as a compressed motion bitstream, which is multiplexed 2690 into the encoder output compressed bitstream. The encoder output compressed bitstream also comprises compressed displacements bitstream and compressed attribute map bitstream.

The encoded base mesh is decoded in the Static Mesh Decoder module that generates a reconstructed quantized base mesh. The Update Displacements/Details 2655 module takes as input the reconstructed quantized base mesh 2610, HF spatial sub-bands displacements 2603 and HF temporal sub-bands 2604 to generate new updated displacements. The updated displacements are filtered with a wavelet transform in the 3D+T Wavelet Transform module 2657 (that also takes as input the reconstructed base mesh) and then quantized in the Quantization module 2659. The quantized wavelet coefficients produced from the updated displacements are then packed into a video component in the Image Packing module 2660. This video component may then be encoded with a 2D video encoder such as HEVC, VVC, etc., in the Video Encoder module 2661, and the output compressed displacement video component sub-bitstream is multiplexed 2690 along with the V3C signalling information sub-bitstream into the output compressed bitstream. Then the compressed displacement video component is first decoded and reconstructed and then unpacked into encoded and quantized wavelet coefficients in the Image Unpacking module 2663. These wavelet coefficients are then unquantized in the inverse quantization module 2665 and reconstructed with the inverse 3D+T wavelet transform module 2667 that generates reconstructed displacements.

The reconstructed base mesh is unquantized in the inverse quantization module 2671 and the unquantized base mesh is combined with the reconstructed displacements in the Reconstruct Deformed Mesh module 2673 to obtain the reconstructed deformed mesh. This reconstructed deformed mesh is then fed into the Attribute Transfer module 2675 together with the Attribute map 2606 produced by the pre-processing and the input static/dynamic mesh frame. The output of the Attribute Transfer module 2675 is an updated attribute map that now corresponds to the reconstructed deformed mesh frame. The updated attribute map is then padded at padding module 2677, and it undergoes color conversion 2679 and is encoded 2681 as a video component with a 2D video codec such as HEVC or VVC, in the Padding, Color Conversion and Video encoder modules respectively. The output compressed attribute map bitstream is multiplexed 2690 into the encoder output bitstream.

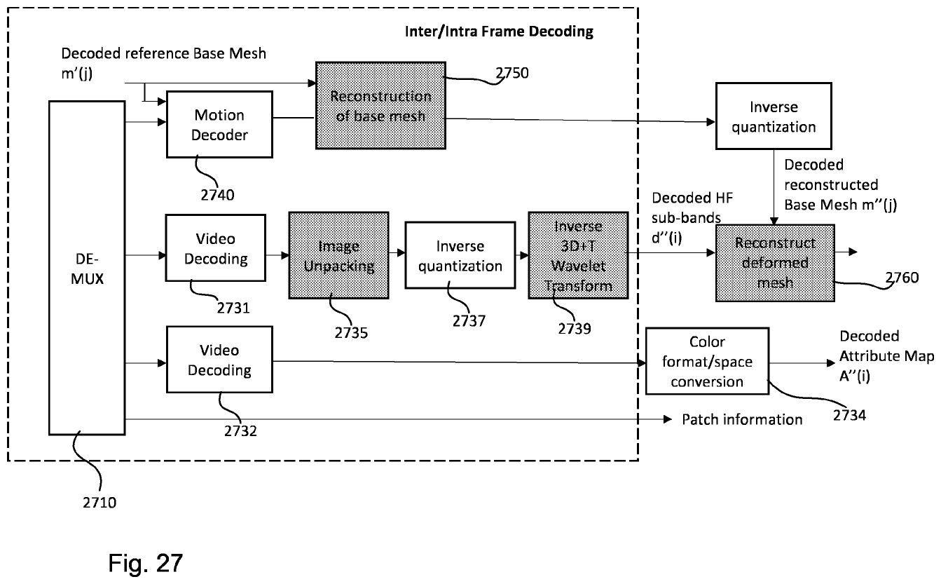

FIG. 27 illustrates modified V-DMC decoding process according to an embodiment. The decoding may comprise decoding each encoded sub-band using the spatio-temporal signalling information extracted from the V-DMC bitstream, unpacking sub-bands if required and as signaled, and performing backward lifting scheme in the specified order that is extracted from the signaling.

A decoded reference base mesh m′(j) is taken as input of a motion decoder module 2740 together with the compressed motion information sub-bitstream obtained from a demultiplex module 2710. This decoded reference base mesh is selected from a buffer of previously decoded base mesh frames (by the intra decoder process for the first frame of a group of frames). The reconstruction of base mesh module 2750 takes the decoded reference base mesh and the decoded motion information as input to produce a decoded reconstructed quantized base mesh.

A compressed displacement video component bitstream produced by the demultiplexing module 2710 is decoded in the video decoding module 2731 to generate a reconstructed displacement video component. This displacement video component is unpacked into reconstructed quantized wavelet coefficients in the image unpacking module 2735. Reconstructed quantized wavelet coefficients are inverse quantized in the inverse quantization module 2737 and then undergo an inverse 3D+T wavelet transform in the inverse wavelet transform module 2739, that produces decoded displacement vectors. The reconstruct deformed mesh module 2760 takes as input the decoded reconstructed base mesh and decoded HF sub-bands to produce the output decoded mesh frame. The compressed attribute map video component provided by the demultiplexing module 2710 is decoded at video coding module 2732, and optionally undergoes color conversion 2734 to produce a decoded attribute map frame that corresponds to the decoded mesh frame.

All the above can be applied at submesh level as well, instead of at full mesh sequence level. This can be beneficial in case a portion of the mesh sequence geometry would benefit from a specialized decomposition; for example, in case a part of the mesh is static while the other parts are dynamic, or in case a part of the mesh is planar or very smooth and does not require many spatial decomposition levels.

The signaling of the spatio-temporal decomposition is as follows:
new values of asps_vmc_ext_transform_index are introduced and the asps_vmc_extension( ) syntax structure is as follows:

| | Descriptor |
|---|---|
| asps_vmc_extension( ) { | |
| asps_vmc_ext_prevent_geometry_video_conversion_flag | u(1) |
| asps_vmc_ext_prevent_attribute_video_conversion_flag | u(1) |
| asps_vmc_ext_subdivision_method | u(3) |
| asps_vmc_ext_subdivision_iteration_count | u(8) |
| asps_vmc_ext_displacement_coordinate_system | u(1) |
| asps_vmc_ext_transform_index | u(3) |
| if(asps_vmc_ext_transform_index == LINEAR_LIFTING) { | |
| vmc_lifting_transform_parameters( 0, 0 ) | |
| } | |
| else if(asps_vmc_ext_transform_index == SPATIO_TEMPORAL) { | |
| vmc_spatio_temporal_transform_parameters( 0, 0 ) | |
| vmc_st_lods_attribute_mapping ( ) | |
| } | |
| ... | |
| if(asps_vmc_ext_attribute_transform_index == LINEAR_LIFTING ) { | |
| asps_vmc_extension_transform_parameters_present_flag[ i ] | u(1) |
| if(asps_vmc_extension_transform_parameters_present_flag[i]) | |
| vmc_lifting_transform_parameters(i+1, 0) | |
| } | |
| if(asps_vmc_ext_attribute_transform_index == | |
| SPATIO_TEMPORAL ) { | |
| asps_vmc_spatio_temporal_transform_parameters_present_fla | u(1) |
| g[i] | |
| if(asps_vmc_spatio_temporal_transform_parameters_present_flag[ i | |
| ]) | |
| vmc_spatio_temporal_transform_parameters(i+1, 0) | |
| } | |
| } | |
| } | |

aps_vmc_ext_transform_index indicates the identifier of the transform applied to the subdivided mesh frames. Table 1 describes the list of supported transform types and their relationship with asps_vmc_ext_transform_index. When asps_vmc_ext_transform_index equals to LINEAR_LIFTING vcm_lifting_transform_parameters syntax structure is present in asps_vmc_extension( ) syntax structure. When asps_vmc_ext_transform_index equals to SPATIO TEMPORAL, vcm_spatio_temporal_transform_parameters( ) syntax structure is present in asps_vcm_extension( ) syntax structure.

asps_vmc_extension spatio temporal transform parameters p resent flag[i] indicates if parameters are available in the atlas sequence parameter set for the spatio-temporal transform for attribute i.

TABLE 1
Mapping of transform index to transform method

| Asps_vmc_ext_transform_index | Name of transform method |
|---|---|
| 0 | NONE |
| 1 | LINEAR_LIFTING |
| 2 | SPATIO_TEMPORAL |

New vmc_spatio_temporal_transform_parameters( ) syntax structure contains the quantization and scaling parameters of a sub-band, and also the prediction and update weights.

| | Descriptor |
|---|---|
| vmc_spatio_temporal_transform_parameters( attributeIndex, sttIndex ){ | |
| vmc_stt_is_leaf_flag[attributeIndex][ sttIndex ] | u(1) |
| vmc_stt_skip_update[attributeIndex][ sttIndex ] | u(1) |
| vmc_stt_quantization_parameters_x[attributeIndex][ sttIndex ] | ue(v) |
| vmc_stt_quantization_parameters_y[attributeIndex][ sttIndex ] | ue(v) |
| vmc_stt_quantization_parameters_z[attributeIndex][ sttIndex ] | ue(v) |
| vmc_stt_log2_lod_inverseScale_x[attributeIndex][ sttIndex ] | ue(v) |
| vmc_stt_log2_lod_inverseScale_y[attributeIndex][ sttIndex ] | ue(v) |
| vmc_stt_log2_lod_inverseScale_z[attributeIndex][ sttIndex ] | ue(v) |
| vmc_stt_log2_update_weight[attributeIndex][ sttIndex ] | ue(v) |
| vmc_stt_log2_prediction_weight[attributeIndex][ sttIndex ] | ue(v) |
| } | |

vmc_stt_is_leaf_flag[attributeIndex] [sttIndex] indicates if the sub-band is used as reference for subsequent sub-bands; if set to 0, it is used as a reference, if set to 1, then the sub-band is not used as reference by any other sub-band.

vmc_stt_skip_update[attributeIndex] [sttIndex] equal to 1 indicates that the step applied to the displacement is skipped in the

vmc_spatio_temporal_transform_parameters (index, sttIndex) syntax structure, where sttIndex is the index of the lifting transform parameter set list.

vmc_transform_lifting_skip_update flag[i] [ltpIndex] with i equal to 0 may be applied to the displacement. vmc_transform_lifting_skip_update_flag[i] [lptIndex] with i equal to non-zero may be applied to the (i−1)-th attribute.

vmc_stt_quantization_parameters_x[attributeIndex] [sttIndex] indicates the quantization parameter to be used for the inverse quantization of the x-component of the wavelets coefficients. The value of vmc_st_quantization_parameters_x[index] [ltpIndex] shall be in the range of 0 to 51, inclusive.

vmc_stt_quantization_parameters_y[attributeIndex] [sttIndex] indicates the quantization parameter to be used for the inverse quantization of the y-component of the wavelets coefficients. The value of vmc_st_quantization_parameters_y [index] [ltpIndex] shall be in the range of 0 to 51, inclusive.

vmc_st_quantization_parameters_z[attributeIndex] [sttIndex] indicates the quantization parameter to be used for the inverse quantization of the z-component of the wavelets coefficients. The value of vmc_st_quantization_parameters_z[index] [ltpIndex] shall be in the range of 0 to 51, inclusive.

vmc_stt_log2_lod_inverseScale_x[attributeIndex] [sttIndex] indicates the scaling factor applied to the x-component of the wavelets coefficients for each LOD.

vmc_stt_log2_lod_inverseScale_y[attributeIndex] [sttIndex] indicates the scaling factor applied to the y-component of the wavelets coefficients for each LOD.

vmc_stt_log2_lod_inverseScale_z[attributeIndex] [sttIndex] indicates the scaling factor applied to the z-component of the wavelets coefficients for each LOD.

vmc_stt_log2_update_weight[attributeIndex] [sttIndex] indicates the weighting coefficients used for the update filter of the wavelet transform.

vmc_stt_log2_prediction_weight[attributeIndex] [sttIndex] the weighting coefficients used for the prediction filter of the wavelet transform.

New vmc_st_lods_attribute_mapping( ) syntax structure is defined:

| | Descriptor |
|---|---|
| vmc_st_lods_attribute_mapping (attributeIndex, sttIndex) { | |
| vmc_st_number_of_subbands_minus1[attributeIndex][sttIndex] | ue(v) |
| for (i = 0 i < | |
| vmc_st_number_of_subbands_minus1[attributeIndex][sttIndex]; | |
| i++) { | |
| vmc_st_subband_type[ i ] | u(3) |
| vmc_st_reference_subband_id[ i ] | ue(v) |
| vmc_st_attribute_index[ i ] | u(7) |
| vmc_st_attribute_packed_flag[ i ] | u(1) |
| if (vmc_st_attribute_packed_flag[ i ]) | |
| vmc_st_attribute_packed_tile_id[ i ] | |
| } | |
| } | |

vmc_st_subband_type indicates the type and frequency band of a spatio-temporal transform sub-band or LOD: temporal or spatial and low or high frequency. In case no decomposition is applied to a given layer, the type is signaled as RAW, in a similar way as the NONE transform method.

| vmc_stt_subband_type | name of subband type |
|---|---|
| 0 | RAW |
| 1 | TEMPORAL_LOW_FREQUENCY |
| 2 | TEMPORAL_HIGH_FREQUENCY |
| 3 | SPATIAL_LOW_FREQUENCY |
| 4 | SPATIAL_HIGH_FREQUENCY |
| 5 | RESERVED |

In another embodiment the syntax can be split into two syntax elements, i.e., vmc_stt_suband_nature representing the type of the sub-band and vmc_stt_suband_frequency representing the frequency band. Those two syntax elements could be guarded by flags. If the flags would indicate that neither type of frequency is present, then a decoder would interpret this as a raw type.

For example,

| vmc_stt_subband_nature | name of subband type |
|---|---|
| 0 | RAW |
| 1 | TEMPORAL |
| 2 | SPATIAL |
| 3 | RESERVED |

| vmc_stt_subband_frequency | name of subband frequency |
|---|---|
| 0 | LOW_FREQUENCY |
| 1 | HIGH FREQUENCY |
| 2 | RESERVED |

vmc_st_lods_structure indicates the structure of the LODs or sub-bands encoded in the V-DMC bitstream.

vmc_st_number_of_subbands_minus1 plus one indicates the number of sub-bands.

vmc_st_subband_type[i] indicates the sub-band type and frequency band as detailed previously.

vmc_st_reference_subband_id[i] indicates the identification of the reference sub-band used to construct the current sub-band number i in the hierarchical spatiotemporal decomposition, if the sub-band is built directly from the original sequence, then vmc_st_reference_subband_id[i] is set to −1.

vmc_st_attribute_index[i] indicates the index of the attribute data carried in LOD data unit indicated by vmc_st_subband_type[i]. The value of vmc_st_attribute_index shall be in the range of 0 to (ai_attribute_count[vuh_atlas_id]−1), inclusive.

vmc_st_attribute_packed_flag[i] equal to 1 indicates that the LOD data is packed in the attribute with index equal to vmc_st_attribute_index[i].

vmc_st_attribute_packed_tile_id[i] indicates the atlas tile ID, corresponding to the region containing data carried in LOD data unit indicated by vmc_st_subband_type[i].

In another embodiment, the signalling could also provide information in case LOD levels are temporally interleaved.

The example provided in FIG. 25 with two levels of temporal decomposition followed by one level of spatial decomposition on the temporal low frequency band would be signaled by vmc_st_lods_parameters syntax structure that would corresponds to the following values once decoded:

| | Value |
|---|---|
| vmc_st_lods_parameters (0, 0) | |
| vmc_st_number_of_subbands_minus1 | 4 |
| vmc_st_subband_type[0] | TEMPORAL_LOW_FREQUENCY |
| vmc_st_reference_subband_id[0] | −1 |
| vmc_st_attribute_index[0] | 0 |
| vmc_st_attribute_packed_flag[ 0 ] | 0 |
| vmc_st_subband_type[1] | TEMPORAL_HIGH_FREQUENCY |
| vmc_st_reference_subband_id[1] | −1 |
| vmc_st_attribute_index[1] | 1 |
| vmc_st_attribute_packed_flag[ 1 ] | 0 |
| vmc_st_subband_type[2] | TEMPORAL_HIGH_FREQUENCY |
| vmc_st_reference_subband_id[2] | 1 |
| vmc_st_attribute_index[2] | 2 |
| vmc_st_attribute_packed_flag[ 2 ] | 0 |
| vmc_st_subband_type[3] | SPATIAL_HIGH_FREQUENCY |
| vmc_st_reference_subband_id[3] | 0 |
| vmc_st_attribute_index[3] | 3 |
| vmc_st_attribute_packed_flag[ 3 ] | 0 |

In another embodiment the vmc_st_lods_attribute_mapping( ) syntax structure can be placed in vps_v3c_vmesh_extension( ) syntax structure that is present in V3C parameter set and provided entry information to V3C bitstream. Placing vmc_st_lods_attribute_mapping( ) syntax structure on V3C parameter set level would allow decoder to make decisions, e.g. to discard the higher level LOD, before parsing any of the V3C subbitstreams.

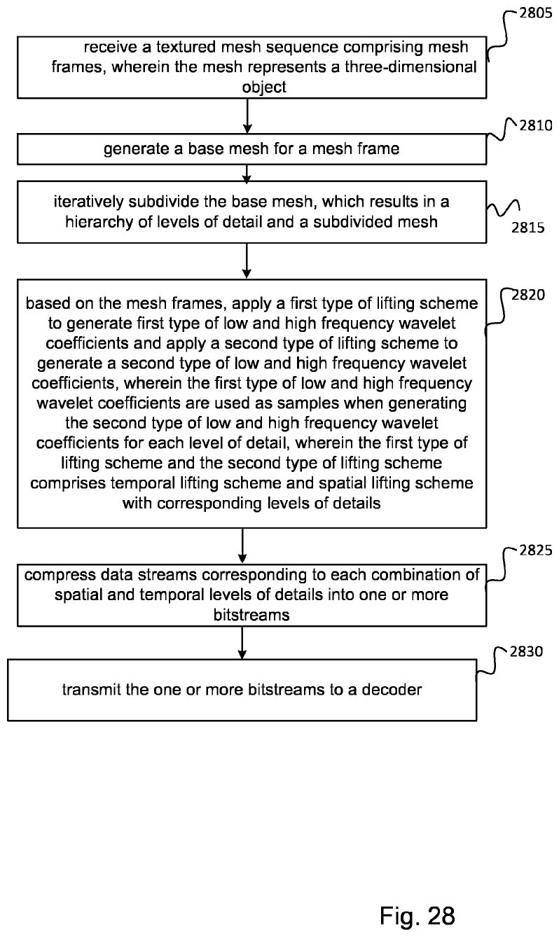

The method for encoding according to an embodiment is shown in FIG. 28. The method generally comprises receiving 2805 a textured mesh sequence comprising mesh frames, wherein the mesh represents a three-dimensional object; generating 2810 a base mesh for a mesh frame; iteratively subdividing 2815 the base mesh, which results in a hierarchy of levels of detail and a subdivided mesh; based on the mesh frames, applying 2820 a first type of lifting scheme to generate first type of low and high frequency wavelet coefficients and applying 2820 a second type of lifting scheme to generate a second type of low and high frequency wavelet coefficients, wherein the first type of low and high frequency wavelet coefficients are used as samples when generating the second type of low and high frequency wavelet coefficients for each level of detail, wherein the first type of lifting scheme and the second type of lifting scheme comprises temporal lifting scheme and spatial lifting scheme with corresponding levels of details; compressing 2825 data streams corresponding to each combination of spatial and temporal levels of details into one or more bitstreams; and transmitting 2830 the one or more bitstreams to a decoder. Each of the steps can be implemented by a respective module of a computer system.

An apparatus according to an embodiment comprises means for receiving a textured mesh sequence comprising mesh frames, wherein the mesh represents a three-dimensional object; means for generating a base mesh for a mesh frame; means for iteratively subdividing the base mesh, which results in a hierarchy of levels of detail and a subdivided mesh; based on mesh frames, means for applying a first type of lifting scheme to generate first type of low and high frequency wavelet coefficients and means for applying a second type of lifting scheme to generate a second type of low and high frequency wavelet coefficients, wherein the first type of low and high frequency wavelet coefficients are used as samples when generating the second type of low and high frequency wavelet coefficients for each level of detail, wherein the first type of lifting scheme and the second type of lifting scheme comprises temporal lifting scheme and spatial lifting scheme with corresponding levels of details; means for compressing data streams corresponding to each combination of spatial and temporal levels of details into one or more bitstreams; and means for transmitting the one or more bitstreams to a decoder. The means comprises at least one processor, and a memory including a computer program code, wherein the processor may further comprise processor circuitry. The memory and the computer program code are configured to, with the at least one processor, cause the apparatus to perform the method of FIG. 28 according to various embodiments.

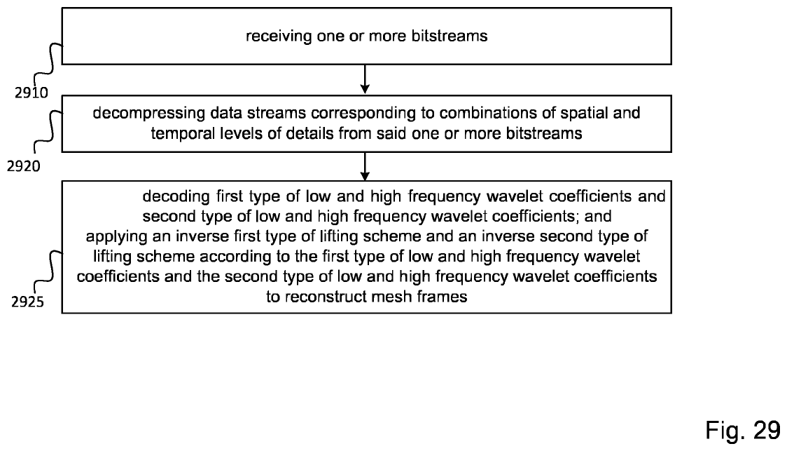

The method for decoding according to an embodiment is shown in FIG. 29. The method generally comprises receiving 2910 one or more bitstreams; decompressing 2920 data streams corresponding to combinations of spatial and temporal levels of details from said one or more bitstreams; decoding 2925 first type of low and high frequency wavelet coefficients and second type of low and high frequency wavelet coefficients; and applying an inverse first type of lifting scheme and an inverse second type of lifting scheme according to the first type of low and high frequency wavelet coefficients and the second type of low and high frequency wavelet coefficients to reconstruct mesh frames. Each of the steps can be implemented by a respective module of a computer system.

An apparatus according to an embodiment comprises means for receiving one or more bitstreams; means for decompressing data streams corresponding to combinations of spatial and temporal levels of details from said one or more bitstreams; means for decoding first type of low and high frequency wavelet coefficients and second type of low and high frequency wavelet coefficients; and means for applying an inverse first type of lifting scheme and an inverse second type of lifting scheme according to the first type of low and high frequency wavelet coefficients and the second type of low and high frequency wavelet coefficients to reconstruct mesh frames. The means comprises at least one processor, and a memory including a computer program code, wherein the processor may further comprise processor circuitry. The memory and the computer program code are configured to, with the at least one processor, cause the apparatus to perform the method of FIG. 29 according to various embodiments.

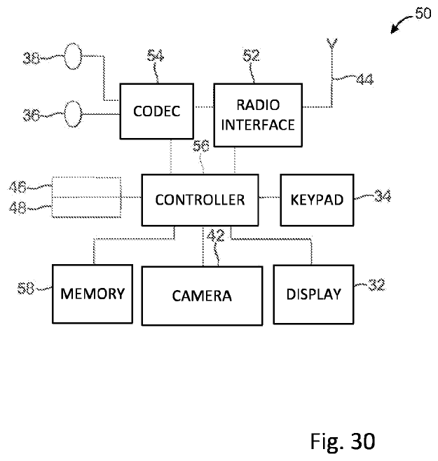

An example of an apparatus is disclosed with reference to FIG. 30. FIG. 30 shows a block diagram of a video coding system according to an example embodiment as a schematic block diagram of an electronic device 50, which may incorporate a codec. In some embodiments the electronic device may comprise an encoder or a decoder. The electronic device 50 may for example be a mobile terminal or a user equipment of a wireless communication system or a camera device. The electronic device 50 may be also comprised at a local or a remote server or a graphics processing unit of a computer. The device may be also comprised as part of a head-mounted display device. The apparatus 50 may comprise a display 32 in the form of a liquid crystal display. In other embodiments of the invention the display may be any suitable display technology suitable to display an image or video. The apparatus 50 may further comprise a keypad 34. In other embodiments of the invention any suitable data or user interface mechanism may be employed. For example, the user interface may be implemented as a virtual keyboard or data entry system as part of a touch-sensitive display. The apparatus may comprise a microphone 36 or any suitable audio input which may be a digital or analogue signal input. The apparatus 50 may further comprise an audio output device which in embodiments of the invention may be any one of: an earpiece 38, speaker, or an analogue audio or digital audio output connection. The apparatus 50 may also comprise a battery (or in other embodiments of the invention the device may be powered by any suitable mobile energy device such as solar cell, fuel cell or clockwork generator). The apparatus may further comprise a camera 42 capable of recording or capturing images and/or video. The camera 42 may be a multi-lens camera system having at least two camera sensors. The camera is capable of recording or detecting individual frames which are then passed to the codec 54 or the controller for processing. The apparatus may receive the video and/or image data for processing from another device prior to transmission and/or storage.

The apparatus 50 may comprise a controller 56 or processor for controlling the apparatus 50. The apparatus or the controller 56 may comprise one or more processors or processor circuitry and be connected to memory 58 which may store data in the form of image, video and/or audio data, and/or may also store instructions for implementation on the controller 56 or to be executed by the processors or the processor circuitry. The controller 56 may further be connected to codec circuitry 54 suitable for carrying out coding and decoding of image, video and/or audio data or assisting in coding and decoding carried out by the controller.

The apparatus 50 may further comprise a card reader 48 and a smart card 46, for example a UICC (Universal Integrated Circuit Card) and UICC reader for providing user information and being suitable for providing authentication information for authentication and authorization of the user at a network. The apparatus 50 may comprise radio interface circuitry 52 connected to the controller and suitable for generating wireless communication signals for example for communication with a cellular communications network, a wireless communications system, or a wireless local area network. The apparatus 50 may further comprise an antenna 44 connected to the radio interface circuitry 52 for transmitting radio frequency signals generated at the radio interface circuitry 52 to other apparatus(es) and for receiving radio frequency signals from other apparatus(es). The apparatus may comprise one or more wired interfaces configured to transmit and/or receive data over a wired connection, for example an electrical cable or an optical fiber connection.

The various embodiments can be implemented with the help of computer program code that resides in a memory and causes the relevant apparatuses to carry out the method. For example, a device may comprise circuitry and electronics for handling, receiving, and transmitting data, computer program code in a memory, and a processor that, when running the computer program code, causes the device to carry out the features of an embodiment. Yet further, a network device like a server may comprise circuitry and electronics for handling, receiving, and transmitting data, computer program code in a memory, and a processor that, when running the computer program code, causes the network device to carry out the features of various embodiments.

If desired, the different functions discussed herein may be performed in a different order and/or concurrently with other. Furthermore, if desired, one or more of the above-described functions and embodiments may be optional or may be combined.

Although various aspects of the embodiments are set out in the independent claims, other aspects comprise other combinations of features from the described embodiments and/or the dependent claims with the features of the independent claims, and not solely the combinations explicitly set out in the claims.

It is also noted herein that while the above describes example embodiments, these descriptions should not be viewed in a limiting sense. Rather, there are several variations and modifications, which may be made without departing from the scope of the present disclosure as, defined in the appended claims.

1-20. (canceled)

21. An apparatus comprising at least one processor, at least one memory comprising computer program code, the memory and the computer program code configured to, with the at least one processor, cause the apparatus to perform at least the following:
receiving a textured mesh sequence comprising mesh frames, wherein the textured mesh sequence represents a three-dimensional object;
generating a base mesh for a mesh frame;
iteratively subdividing the base mesh, which results in a hierarchy of levels of detail and a subdivided mesh;
based on the mesh frames, apply a first type of lifting scheme to generate first type of low and high frequency wavelet coefficients and apply a second type of lifting scheme to generate a second type of low and high frequency wavelet coefficients, wherein the first type of low and high frequency wavelet coefficients are used as samples when generating the second type of low and high frequency wavelet coefficients for each level of detail, wherein the first type of lifting scheme and the second type of lifting scheme comprises a temporal lifting scheme and a spatial lifting scheme with corresponding levels of details;
compressing data streams corresponding to each combination of spatial and temporal levels of details into one or more bitstreams; and
transmitting the one or more bitstreams to a decoder.

22. The apparatus according to claim 21, wherein the first type of lifting scheme and the second type of lifting scheme are applied on a level following a lowest level of detail based on the base mesh frames and subdivided mesh frames at said level following the lowest level of detail.

23. The apparatus according to claim 22, wherein the first type of lifting scheme and the second type of lifting scheme are applied on subsequent levels based on mesh frames subdivided at previous level of details and mesh frames subdivided at current level of detail.

24. The apparatus according to claim 21, wherein the first type of lifting scheme comprises the temporal lifting scheme, wherein the apparatus is further caused to perform: separating mesh frames into two subsequences according to frame indices and defining temporal low and high frequency wavelet coefficients according to said subsequences.

25. The apparatus according to claim 21, wherein the first type of lifting scheme comprises the spatial lifting scheme, wherein the apparatus is further caused to perform: using base meshes as low frequency spatial wavelet coefficients and using filtered displacement vectors as high-frequency spatial wavelet coefficients.

26. The apparatus according to claim 21, wherein the apparatus is further caused to perform: predicting the second type of low and high frequency wavelet coefficients based on the first type of low and high frequency wavelet coefficients.

27. The apparatus according to claim 21, wherein the apparatus is further caused to perform: encoding into or along a bitstream information on the used temporal lifting scheme and spatial lifting scheme for a frame or a sequence.

28. The apparatus according to claim 21, wherein the apparatus is further caused to perform: encoding into or along a bitstream information on type and frequency band of a lifting scheme subband or level of detail.

29. An apparatus comprising at least one processor, at least one memory comprising computer program code, the memory and the computer program code configured to, with the at least one processor, cause the apparatus to perform at least the following:
receiving one or more bitstreams;
decompressing data streams corresponding to combinations of spatial and temporal levels of details from said one or more bitstreams;
decoding first type of low and high frequency wavelet coefficients and second type of low and high frequency wavelet coefficients; and
applying an inverse first type of lifting scheme and an inverse second type of lifting scheme according to the first type of low and high frequency wavelet coefficients and the second type of low and high frequency wavelet coefficients to reconstruct mesh frames.

30. A method, comprising:
receiving a textured mesh sequence comprising mesh frames, wherein the textured mesh sequence represents a three-dimensional object;
generating a base mesh for a mesh frame;
iteratively subdividing the base mesh, which results in a hierarchy of levels of detail and a subdivided mesh;
based on the mesh frames, applying a first type of lifting scheme to generate first type of low and high frequency wavelet coefficients and applying a second type of lifting scheme to generate a second type of low and high frequency wavelet coefficients, wherein the first type of low and high frequency wavelet coefficients are used as samples when generating the second type of low and high frequency wavelet coefficients for each level of detail, wherein the first type of lifting scheme and the second type of lifting scheme comprises a temporal lifting scheme and a spatial lifting scheme with corresponding levels of details;
compressing data streams corresponding to each combination of spatial and temporal levels of details into one or more bitstreams; and
transmitting the one or more bitstreams to a decoder.

31. The method according to claim 30, wherein the first type of lifting scheme and the second type of lifting scheme are applied on a level following a lowest level of detail based on the base mesh frame and subdivided mesh frames at said level following the lowest level of detail.

32. The method according to claim 31, wherein the first type of lifting scheme and the second type of lifting scheme are applied on subsequent levels based on mesh frames subdivided at previous level of details and mesh frames subdivided at current level of detail.

33. The method according to claim 30, wherein the first type of lifting scheme comprises the temporal lifting scheme, wherein the method further comprises separating mesh frames into two subsequences according to frame indices and defining temporal low and high frequency wavelet coefficients according to said subsequences.

34. The method according to claim 30, wherein the first type of lifting scheme comprises the spatial lifting scheme, wherein the method further comprises using base meshes as low frequency spatial wavelet coefficients and using filtered displacement vectors as high-frequency spatial wavelet coefficients.

35. The method according to claim 30, further comprising predicting the second type of low and high frequency wavelet coefficients based on the first type of low and high frequency wavelet coefficients.

36. The method according to claim 30, further comprising encoding into or along a bitstream information on the used temporal lifting scheme and spatial lifting scheme for a frame or a sequence.

37. The method according to claim 30, further comprising encoding into or along a bitstream information on type and frequency band of a lifting scheme subband or level of detail.

38. A method, comprising:
receiving one or more bitstreams;
decompressing data streams corresponding to combinations of spatial and temporal levels of details from said one or more bitstreams;
decoding first type of low and high frequency wavelet coefficients and second type of low and high frequency wavelet coefficients; and
applying an inverse first type of lifting scheme and an inverse second type of lifting scheme according to the first type of low and high frequency wavelet coefficients and the second type of low and high frequency wavelet coefficients to reconstruct mesh frames.
